(19) United States
(12) Patent Application Publication
(10) Pub. No.: US 2026/0247280 A1
(43) Pub. Date: Aug. 20, 2026

(54) NETWORK ENERGY SAVING CELL INFORMATION

(71) Applicant: SHARP KABUSHIKI KAISHA, Osaka (JP)

(72) Inventor: Atsushi ISHII, Vancouver, WA (US)

(21) Appl. No.: 19/156,229

(22) PCT Filed: Jan. 26, 2024
(86) PCT No.: PCT/JP2024/002327

§ 371 Date: Aug. 13, 2025

Related U.S. Application Data
(60) Provisional application No. 63/484,911, filed on Feb. 14, 2023.

(51) Int. Cl. H04W 52/02; H04W 76/28

(52) U.S. Cl. CPC H04W 52/0206; H04W 76/28

(57) ABSTRACT

A wireless terminal of a cellular telecommunication system comprises receiver circuitry and processor circuitry. The receiver circuitry is configured to receive, from an anchor cell, network energy saving, NES, cell information comprising an identity of a NES cell associated with the anchor cell. The NES cell is a cell that refrains from periodically transmitting broadcast signals for energy saving. The processor circuitry is configured to perform, based on the NES cell information, an idle/inactive mode procedure.

### TECHNICAL FIELD

The technology relates to wireless communications, and particularly to access and/or communications to cells that facilitate network energy savings.

### BACKGROUND ART

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and g-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR” ] technology system), or some other similar terminology.

The 3rd Generation Partnership Project (“3GPP”) is a group that, e.g., develops col-laboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprised of NG RAN, Next Generation Radio Access Network, and 5GC, 5G Core Network. As shown, NGRAN is comprised of gNBs, e.g., 5G Base stations, and ng-eNBs, i.e., LTE base stations. An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations, i.e., gNB & ng-eNB. A gNB node provides NR user plane and control plane protocol terminations towards the UE, and is connected via the NG interface to the 5GC. The 5G NR, New Radio, gNB is connected to AMF, Access and Mobility Management Function, and UPF, User Plane Function, in the 5GC, 5G Core Network.

Nowadays network energy saving (NES) is of great importance for environmental sustainability, for example to reduce environmental impact, e.g., greenhouse gas emissions, and for operational cost savings. Fifth generation system, e.g., 5G, is becoming pervasive across industries and geographical areas. The 5G systems typically handle more advanced services and applications requiring very high data rates, and typically involve more dense networks, more antennas, larger bandwidths, and more frequency bands.

Thus, network operators should conserve energy. According to the report from GSMA, “5G energy efficiencies: Green is the new black”, (https://data.gsmaintelligence.com/api-web/v2/research-file-download?id=54165956&f ile=241120-5G-energy.pdf), incorporated herein by reference in its entirety, the energy cost on mobile networks accounts for about 23% of the total operator cost. Most of the energy consumption comes from the radio access network and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not ongoing.

What is needed are methods, apparatus, and/or techniques to improve network energy savings, and particularly energy savings in transmissions of cells of a radio access network.

### SUMMARY OF INVENTION

In one of its example aspects the technology disclosed herein concerns a wireless terminal of a cellular telecommunication system. The wireless terminal includes: receiver circuitry configured to receive, from an anchor cell, network energy saving (NES) cell information comprising an identity of a NES cell associated with the anchor cell, the NES cell being a cell that refrains from periodically transmitting broadcast signals for energy saving; and, processor circuitry configured to perform, based on the NES cell information, an idle/inactive mode procedure.

In one of its example aspects the technology disclosed herein concerns an access node of a cellular telecommunication system. The access node includes: processor circuitry configured to generate network energy saving (NES) cell information, the NES cell information being configured for use by a wireless terminal to perform an idle/inactive mode procedure and comprising an identity of a NES cell which refrains from periodically transmitting broadcast signals for energy saving; and, transmitter circuitry configured to transmit the NES cell information via an anchor cell to the wireless terminal.

In one of its example aspects the technology disclosed herein concerns a method for a wireless terminal of a cellular telecommunication system. The method includes: receiving, from an anchor cell, network energy saving (NES) cell information comprising an identity of a NES cell associated with the anchor cell, the NES cell being a cell that refrains from periodically transmitting broadcast signals for energy saving; and, performing an idle/inactive mode procedure based on the NES cell information.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 a diagrammatic view of an example cellular telecommunication system comprising at least some network energy saving cells, e.g., NES cells.

FIG. 3 is a flowchart showing example acts, steps, or operations that a wireless terminal may perform to access an SIB/SSB-less NES cell.

FIG. 4 is a diagrammatic view of a communications system showing an access node of a non-NES cell that supplies NES cell information to a wireless terminal according to an example embodiment and mode.

FIG. 5 is a flowchart view showing representative, example steps or acts performed by a wireless terminal of the communications system of the example embodiment and mode of FIG. 4.

FIG. 6 is a flowchart view showing representative, example steps or acts performed by a mobile base station relay node of the communications system of the example embodiment and mode of FIG. 4.

FIG. 7 is a diagrammatic view of a communications system wherein an anchor access node provides system information for a network energy saving cell, which system information is acquired by a wireless terminal according to an example embodiment and mode.

FIG. 8 is a flowchart view showing representative, example steps or acts performed by a wireless terminal of the communications system of the example embodiment and mode of FIG. 7.

FIG. 9 is a flowchart view showing representative, example steps or acts performed by a mobile base station relay node of the communications system of the example embodiment and mode of FIG. 7.

FIG. 10 is a diagrammatic view of a communications system wherein an anchor access node provides system information including NES system information (SI) request configuration information for configuring on-demand system information to be broadcasted by the NES cell according to an example embodiment and mode.

FIG. 11 is a diagrammatic view of a scenario of general operation of the system of FIG. 10 according to an example mode.

FIG. 12 is a diagrammatic view of a scenario of general operation of the system of FIG. 10 according to an example two-step mode.

FIG. 13 is a diagrammatic view of a scenario of general operation of the system of FIG. 10 according to an example four-step mode.

FIG. 14 is a flowchart view showing representative, example steps or acts performed by a wireless terminal of the communications system of the example embodiment and mode of FIG. 10 and FIG. 11.

FIG. 15 is a flowchart view showing representative, example steps or acts performed by a mobile base station relay node of the communications system of the example embodiment and mode of FIG. 10 and FIG. 11.

FIG. 16 is a diagrammatic view of a communications system wherein an anchor access node provides system information including NES Synchronization Signal Block (SSB) request configuration information for configuring on-demand Synchronization Signal Block (SSB) to be broadcasted by the NES cell according to an example embodiment and mode.

FIG. 17 is a diagrammatic view of a scenario of general operation of the system of FIG. 16 according to an example mode.

FIG. 18 is a diagrammatic view of a scenario of general operation of the system of FIG. 16 according to an example two-step mode.

FIG. 19 is a diagrammatic view of a scenario of general operation of the system of FIG. 16 according to an example four-step mode.

FIG. 20 is a flowchart view showing representative, example steps or acts performed by a wireless terminal of the communications system of the example embodiment and mode of FIG. 16 and FIG. 17.

FIG. 21 is a flowchart view showing representative, example steps or acts performed by a mobile base station relay node of the communications system of the example embodiment and mode of FIG. 16 and FIG. 17.

FIG. 22 is a diagrammatic view of a communications system which provides cell barring for network energy saving cells according to an example embodiment and mode.

FIG. 23 is a flowchart view showing representative, example steps or acts performed by the communications system of the example embodiment and mode of FIG. 22.

FIG. 24 is a flowchart view showing representative, example steps or acts performed by a wireless terminal of the communications system of the example embodiment and mode of FIG. 22.

FIG. 25 is a flowchart view showing representative, example steps or acts performed by a mobile base station relay node of the communications system of the example embodiment and mode of FIG. 22.

FIG. 26 is a diagrammatic view showing example elements comprising electronic machinery which may comprise a wireless terminal, a radio access node, and a core network node according to an example embodiment and mode.

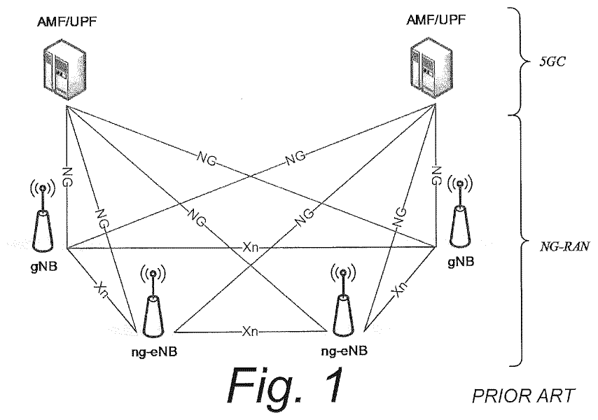

### DESCRIPTION OF EMBODIMENTS

In one of its example aspects the technology disclosed herein concerns a wireless terminal of a cellular telecommunication system which comprises receiver circuitry and processor circuitry. The receiver circuitry is configured to receive, from an anchor cell, network energy saving, NES, cell information comprising an identity of a NES cell associated with the anchor cell, the NES cell being a cell that refrains from periodically transmitting broadcast signals for energy saving. The processor circuitry is configured to perform, based on the NES cell information, an idle/inactive mode procedure. Methods of operating such wireless terminals are also provided.

In another of its example aspects the technology disclosed herein concerns an access node of a cellular telecommunication system that comprises processor circuitry and transmitter circuitry. The processor circuitry is configured to generate network energy saving (NES) cell information. The NES cell information is configured for use by a wireless terminal to perform an idle/inactive mode procedure and comprises an identity of a NES cell which refrains from periodically transmitting broadcast signals for energy saving. The transmitter circuitry is configured to transmit, via an anchor cell, to the wireless terminal, the NES cell information. Methods of operating such access nodes are also provided.

In another of its example aspects the technology disclosed herein concerns a wireless terminal of a cellular telecommunication system which comprises receiver circuitry and processor circuitry. The receiver circuitry is configured to receive, from an anchor cell, network energy saving (NES) cell information comprising: an identity of a NES cell associated with the anchor cell, and essential information. The essential information comprises information required to access the NES cell. The processor circuitry is configured to access the NES cell using the NES information. Methods of operating such wireless terminals are also provided.

In another of its example aspects the technology disclosed herein concerns an access node of a cellular telecommunication system that comprises processor circuitry and transmitter circuitry. The processor circuitry is configured to generate network energy saving (NES) cell information comprising: an identity of a NES cell associated with an anchor cell, and essential information. The essential information comprises information required to access the NES cell. The transmitter circuitry is configured to transmit, via an anchor cell, to a wireless terminal, the NES cell information. Methods of operating such access nodes are also provided.

In another of its example aspects the technology disclosed herein concerns a wireless terminal of a cellular telecommunication system which comprises receiver circuitry processor circuitry, and transmitter circuitry. The receiver circuitry is configured to receive, from an anchor cell, network energy saving (NES) cell information comprising: an identity of a NES cell associated with the anchor cell and NES system information (SI) request configuration information configuring on-demand system information to be broadcasted by the NES cell. The processor circuitry is configured to generate, based on the NES SI request configuration information, a request message for the on-demand system information. The transmitter circuitry is configured to transmit, to the anchor cell, the request message. Methods of operating such wireless terminals are also provided.

In another of its example aspects the technology disclosed herein concerns an access node of a cellular telecommunication system that comprises processor circuitry and transmitter circuitry. The processor circuitry is configured to generate network energy saving (NES) cell information comprising: an identity of a NES cell associated with an anchor cell; and NES system information (SI) request configuration information configuring on-demand system information to be broadcasted by the NES cell. The NES cell information is configured for use by a wireless terminal to send, to the anchor cell, a request message for the on-demand system information. The transmitter circuitry is configured to transmit the NES cell information via the anchor cell to the wireless terminal. Methods of operating such access nodes are also provided.

In another of its example aspects the technology disclosed herein concerns a wireless terminal of a cellular telecommunication system which comprises receiver circuitry processor circuitry, and transmitter circuitry. The receiver circuitry is configured to receive, from an anchor cell, network energy saving (NES) cell information comprising an identity of a NES cell associated with the anchor cell and NES Synchronization Signal Block (SSB) request configuration information configuring on-demand SSBs to be transmitted by the NES cell. The processor circuitry is configured to generate, based on the NES SSB request configuration information, a request message for the on-demand SSBs. The transmitter circuitry is configured to transmit the request message to the anchor cell. Methods of operating such wireless terminals are also provided.

In another of its example aspects the technology disclosed herein concerns an access node of a cellular telecommunication system that comprises processor circuitry and transmitter circuitry. The processor circuitry is configured to generate network energy saving (NES) cell information comprising an identity of a NES cell associated with an anchor cell and NES Synchronization Signal Block (SSB) request configuration information configuring on-demand SSBs to be transmitted by the NES cell. The NES cell information is configured for used by the wireless terminal to send, to the anchor cell, a request message for the on-demand SSBs. The transmitter circuitry is configured to transmit, via the anchor cell, to a wireless terminal, the NES cell information. Methods of operating such access nodes are also provided.

In another of its example aspects the technology disclosed herein concerns a wireless terminal of a cellular telecommunication system which comprises receiver circuitry and processor circuitry. The receiver circuitry is configured to receive, from a first cell, a Synchronization Signal Block (SSB) comprising an indication indicating that the first cell does not provide system information. The processor circuitry is configured to perform a cell selection/reselection procedure to determine, based on the SSB, whether or not to select/reselect the cell. In a case that the wireless terminal has received, from an anchor cell, network energy saving (NES) cell information indicating that the first cell is an NES cell associated with the anchor cell, the first cell is treated as a candidate for the cell selection/reselection procedure. Methods of operating such wireless terminals are also provided.

In another of its example aspects the technology disclosed herein concerns an access node of a cellular telecommunication system that comprises processor circuitry and transmitter circuitry. The processor circuitry is configured to generate a Synchronization Signal Block (SSB) comprising an indication indicating that a first cell served by the access node does not provide system information. The transmitter circuitry configured to transmit, via the first cell, to a wireless terminal, the SSB. The indication is configured to be used by the wireless terminal to perform a cell selection/reselection procedure to determine whether or not to select/reselect the cell. In a case that the wireless terminal has received, from an anchor cell, network energy saving (NES) cell information indicating that the first cell is an NES cell associated with the anchor cell, the first cell is treated as a candidate for the cell selection/reselection procedure. Methods of operating such access nodes are also provided.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

### 0.0 Introduction: Generic Network Architecture and Terminology

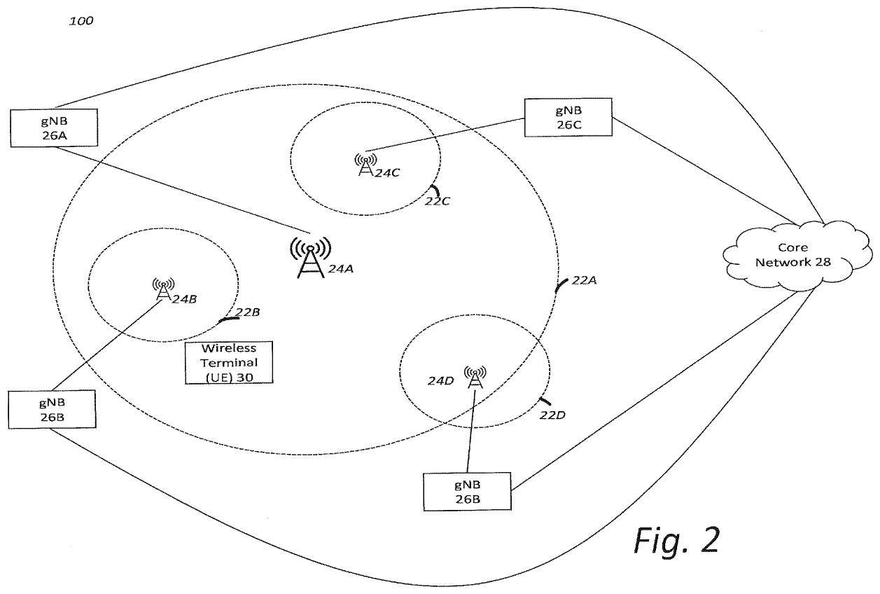

FIG. 2 shows an example system diagram of a cellular telecommunication system. The cellular communication system 20 comprises cells 22A-22D, each cell being generically referred to as a cell 22. Each of the cells 22 may be served by at least one Transmission and Reception Point 24 (TRPs24), such as TRP 24A which serves cell 22A, TRP 24B which serves cell 22B, TRP 22B which serves cell 22B, TRP 24C which serves cell 22C, and TRP 22D which serves cell 22D. Furthermore, each of the TRPs 24 may be controlled by an access node or gNB 26, such as gNB 26A which controls TRP 24A, gNB 26B which controls TRP 24B, gNB 26C which controls TRP 24C, and gNB 26D which controls TRP 24D. These gNBs 26 may be connected to core network 28. In the following embodiments and modes, it is assumed that cells 22B, 22C, and 22D of FIG. 2 are network energy saving cells, NES cells, whereas cell 22A is a regular cell, e.g., a non-NES cell.

FIG. 2 further shows that a wireless terminal 30 may be served by one or more cells 22. The cells 22 and their respective access nodes or gNBs 26 comprise a radio access network 32 which includes and serves the wireless terminal 30. In the radio access network 32 the wireless terminal 32 communicates across a radio or wireless interface 33 with one or more cells 22, e.g., access nodes 26.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel. All or a subset of the cell may be adopted by 3GPP as licensed bands, e.g., frequency band, to be used for communication between a base station, such as a Node B, and a UE terminal. A cellular network using frequency bands can include configured cells. Configured cells can include cells of which a UE terminal is aware and in which it is allowed by a base station to transmit or receive information. Examples of cellular radio access networks include E-UTRAN or New Radio, NR, and any successors thereof, e.g., NUTRAN.

A core network, CN, such as core network (CN) 28 may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. For example, core network (CN) 28 may comprise one or more management entities, which may be an Access and Mobility Management Function, AMF.

A radio access network, RAN, typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR” ] technology system), or some other similar terminology.

As used herein, for a UE in IDLE Mode, a “serving cell” is a cell on which the wireless terminal in idle mode is camped. See, e.g., 3GPP TS 38.304. For a UE in RRC_CONNECTED not configured with carrier aggregation, CA/dual connectivity, DC, there is only one serving cell comprising the primary cell. For a UE in RRC_CONNECTED configured with CA/DC the term ‘serving cells’ is used to denote the set of cells comprising of the Special Cell(s) and all secondary cells. See, e.g., 3GPP TS 38.331.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

The wireless terminal communicates with its serving radio access network over a radio or air interface. Communication between radio access network (RAN) 32 and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element, RE, is the smallest time-frequency unit for downlink transmission in the subframe. That is, one symbol on one sub-carrier in the sub-frame comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix.

In 5G New Radio (“NR”), a frame consists of 10 ms duration. A frame consists of 10 subframes with each having 1 ms duration similar to LTE. Each subframe consists of 2 slots. Each slot can have either 14 (normal CP) or 12 (extended CP) OFDM symbols. A Slot is typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slot helps to achieve lower latency in 5G NR architecture. Unlike slot, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

As understood from the foregoing, the radio access network in turn communicates with one or more core networks (CN) 102 over a RAN-CN interface (e.g., N2 interface).

One of the possible network power saving techniques currently being discussed in 3GPP is a network energy saving, NES, cell which does not regularly transmit broadcast signals to save energy. For example, in one configuration, some NES cells may not regularly transmit system information, such as System Information Block Type 1, SIB1. Such a cell may be referred to as a “SIB-less cell”.

In another configuration, some NES cells may not regularly transmit system information as well as Synchronization Signal Block (SSB) for further energy saving (referred as “SIB/SSB-less”).

In either SIB-less or SIB/SSB-less operation, a non-NES cell may serve as an “anchor cell”. An anchor cell may provide essential information on behalf of associated NES cells. As used herein, “essential information” is or comprises information that is required or necessary to access a cell such as a NES cell. The essential information may include, but not be limited to, synchronization information, e.g., slot timing, (sub)frame timing, etc., and system information for NES cells, to help a wireless terminal, e.g., a user equipment (UE) when accessing the NES cells. In FIG. 2, cell 22A is an anchor cell associated with NES cells 22B, 22C, and 22D.

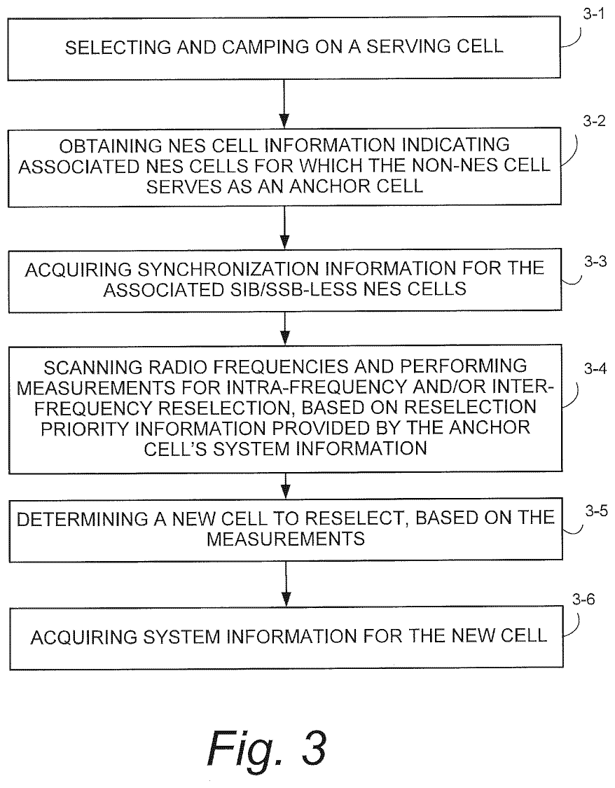

To access an SIB/SSB-less NES cell, a wireless terminal, such as wireless terminal 30 of FIG. 2, may execute example acts, steps, or operations such as those shown in FIG. 3. The acts of FIG. 3 may or may not be executed in the order presented.

Act 3-1 of FIG. 3 comprises selecting and camping on a serving cell. The serving cell may potentially be an anchor cell.

Act 3-2 comprises obtaining NES cell information indicating associated NES cells for which the non-NES cell serves as an anchor cell. Act 3-2 presumes that the NES cell information is provided in the serving cell's system information. If no NES cell information is provided, the serving cell may not be an anchor cell.

Act 3-3 comprises acquiring synchronization information for the associated SIB/SSB-less NES cells.

Act 3-4 comprises scanning radio frequencies and performing measurements for intra-frequency and/or inter-frequency reselection, based on reselection priority information provided by the anchor cell's system information.

Act 3-5 comprises determining a new cell to reselect based on the measurements of act 3-4.

Act 3-6 comprises acquiring system information for the new cell. If the new cell is one of the NES cells indicated in the NES cell information obtained in act 3-2, the wireless terminal 30 may use the system information acquired from the anchor cell by either a method disclosed in an example embodiment and mode described, e.g., in Section 2.0 hereof or a method disclosed in an example embodiment and mode described, e.g., in Section 3.0 hereof. Otherwise, the wireless terminal 30 acquires the system information from the new cell.

### 1.0: Network Energy Saving Cell Information

In an example embodiment and mode of the technology disclosed herein discloses and concerns a method and apparatus for performing act 3-2 of FIG. 3 wherein the anchor cell may provide the wireless terminal NES cell information, e.g., information indicating NES cells associated with the anchor cell. Such NES cells may be in proximity to the anchor cell, since the wireless terminal may be required to obtain, from the anchor cell, essential information, e.g., synchronization timing and/or the system information of the NES cells, to access one of the NES cells. Therefore, the NES cells may be neighboring cells of the anchor cell. As used herein, an NES cell may include a cell that refrains from periodically transmitting broadcast signals for energy saving.

### 1.1:Network Energy Saving Cell Information:Example Architecture

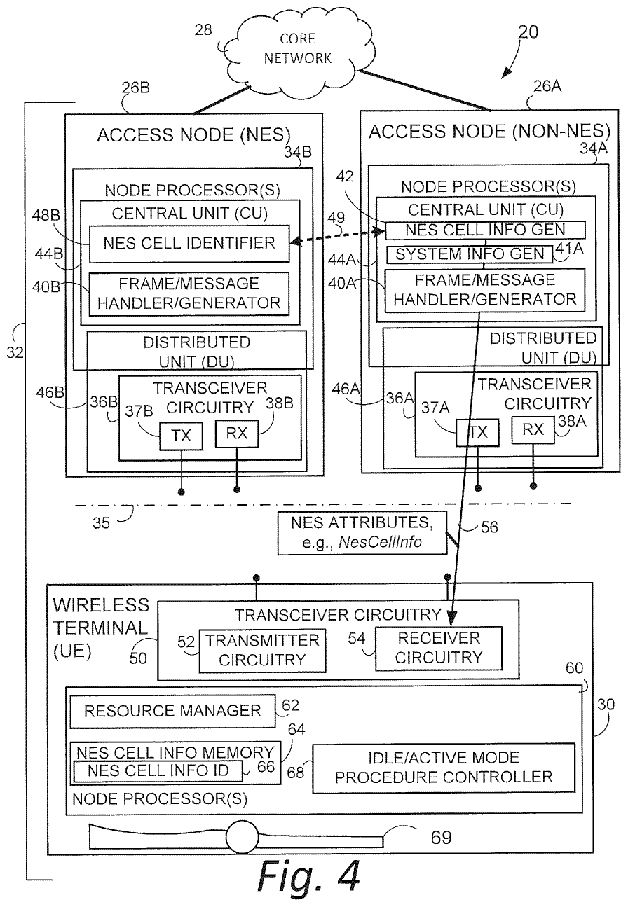

FIG. 4 shows, in generic manner, a communications network or system, which may be a 5G network, for example. The communications system of FIG. 4 and section 1.0, as well as communications systems of other example embodiments and modes and sections hereof, may comprise core network 28 connected to at least one radio access network 32. The radio access network 32 in turn comprises one or more radio access network (RAN) nodes, such as example base station nodes 26A and 26B which are shown as being connected to the core network 28 by wireline(s). As mentioned above, the base station node 26A may be an anchor access node, e.g., an access node for a non-NES cell, e.g., cell 22A of FIG. 2, while the base station node 26B may be an access node for a NES cell, e.g., cell 22B of FIG. 2.

FIG. 4 shows the radio access network 32, and access node 26A through its cell in particular communicating with wireless terminal 30 across radio or air interface 33. The access node 26A may, and usually does, communicate with plural wireless terminals across the air interface 33. Only one wireless terminal 30 is shown for sake of simplicity, it being understood that other wireless terminals may be provided and may operate in similar manner as the wireless terminal 30 herein illustrated.

FIG. 4 shows access node 26A as comprising access node processor circuitry which may comprise one or more access node processors 34A, as well as access node transceiver circuitry 36A. As illustrated in FIG. 2, the access node transceiver circuitry 36 may be a transmission and reception point (TRP) 24. The transmission and reception point (TRP) 36 may further comprise transmitter circuitry and receiver circuitry, e.g., access node transmitter circuitry 36A and access node receiver circuitry 37A. The transmission and reception point (TRP) 24 may either be co-located with other equipment of the access node 26, or remote therefrom as shown in FIG. 2.

The access node processors 34 may comprise access node frame/message handler/generator 40 which prepares and generates information including user data and messages, e.g., signaling, for transmission over the radio interface 33, and which also processes information received over the radio interface 33. The access node processors 34A of access node 26A may also comprise system information block, SIB, generator 41A, which serves to generate or at least store system information which is broadcast over the radio interface 32. The access node processors 34A of access node 26A may also include NES cell information generator 42, which may be included with or working in conjunction with the system information block, SIB, generator 41A and/or access node frame/message handler/generator 40.

The access node 26A may or may not have a split architecture as shown in FIG. 4, in which access node 26A comprises a central unit 44A and one or more distributed units 46A that comprise mobile termination (MT). The access node processor(s) may include one or more TRPs 24A.

In addition to the non-NES access node 26A, FIG. 4 also shows an NES access node 26B. Structure and functionalities which are common to both the access node 26A and access node 26B employ same reference numbers, but with different alphabetical suffixes A, B to denote the respective access node 26A and access node 26B. The access node 26B may or may not have the distributed architecture as shown in FIG. 4, and the fact that one or other of the access node 26A or access node 26B has distributed architecture does not require that other access nodes have distributed architecture.

A difference between the access node 26A and access node 26B is that access node 26A includes the NES cell information generator 42 which generates NES cell information for one or more NES cells, such as cell 22B, for example. Descriptions of NES cell information are provided herein, but for now it is mentioned that the NES cell information for a NES cell includes an identifier of the NES cell for which the NES cell information pertains. In this regard, FIG. 4 shows access node 26B as comprising a memory for NES cell identification information, e.g., NES cell identifier memory 48. Arrow 49 represents an association of a record or storage of NES cell information in NES cell information generator 42 for the NES cell 22B served by access node 26B. Although not shown in FIG. 4, NES cell information generator 42 may have asso-ciations also with other cells 22 served by other access nodes 26, such as one or more of other access nodes 26C and 26D, for example.

Communication between radio access network (RAN) 22 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”, as described, and defined previously herein.

FIG. 4 also shows various example constituent components and functionalities of wireless terminal 30. For example, FIG. 4 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

In the generic example embodiment and mode of FIG. 4 terminal receiver circuitry 54 is configured to receive, over the radio interface 33 from non-NES access node 26A, e.g., NES cell information as generated by NES cell information generator 42. Arrow 56 represents the transmission of the NES cell information from access node 26A to wireless terminal 30. Examples of specific information included in NES cell information are described herein.

FIG. 4 further shows wireless terminal 30 also comprising wireless terminal processor circuitry, e.g., one or more wireless terminal processor(s) 60. The wireless terminal 30, e.g., wireless terminal processor(s) 60, may comprise resource manager 62. The resource manager 62 may also be referred to or function as a frame/message generator/handler. The wireless terminal processor(s) 60 may also comprise or work in conjunction with NES cell information memory 64, in which the NES cell information received by wireless terminal 30 (as shown by arrow 56) is stored. The NES cell information generator may include the NES cell identifier, indicated by memory location 66.

In addition, wireless terminal processor(s) 60 comprise idle/active mode procedure controller 68.

The wireless terminal 30 may also comprise user interfaces 69, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

Thus, the example embodiment and mode of FIG. 4 and section 1.0 hereof concerns a wireless terminal of a cellular telecommunication system, such as wireless terminal 30, which comprises receiver circuitry and processor circuitry, such as terminal receiver circuitry 54 and wireless terminal processor(s) 60, respectively, for example. The receiver circuitry is configured to receive, from an anchor cell, network energy saving, NES, cell information comprising an identity of a NES cell associated with the anchor cell. The NES cell is a cell that refrains from periodically transmitting broadcast signals for energy saving. The processor circuitry is configured to perform, based on the NES cell information, an idle/inactive mode procedure.

The example embodiment and mode of FIG. 4 and section 1.0 hereof also concerns an access node of a cellular telecommunication system, such as access node 26A, that comprises processor circuitry and transmitter circuitry, such as access node processors 34A and transmitter circuitry 37A, respectively, for example. The processor circuitry is configured to generate network energy saving (NES) cell information. The NES cell information is configured for use by a wireless terminal to perform an idle/inactive mode procedure and comprises an identity of a NES cell which refrains from periodically transmitting broadcast signals for energy saving. The transmitter circuitry is configured to transmit, via an anchor cell, to the wireless terminal, the NES cell information.

### 1.2:Network Energy Saving Cell Information:Example Operation

One example implementation of the example embodiment and mode of FIG. 4 and section 1.0 hereof may comprise the anchor cell broadcasting the NES cell information, preferably in neighboring cell lists, with a NES attribute(s) for each of the NES cells. Such a NES attribute(s) may indicate “SIB-less”, “SIB/SSB-less” or others. Listing 1 shows an example format of the intra-frequency neighboring cell information, e.g., SIB3, and inter-frequency neighboring cell information, e.g., SIB4, wherein for each intra-frequency or inter-frequency neighboring cell in SIB3 or SIB4, an information element “NesCellInfo” may be optionally appended. The information element, if present, may indicate that the corresponding neighboring cell identified by phyCellId, physical cell ID or PCI, of IntraFreaNeighCellTnfo for SIB3, or InterFreqNeighCellInfo for SIB4 is a NES cell, and may further indicate that the NES cell is a SIB-less cell, a SIB/SSB-less cell or a cell of any other attribute, nesType. If the information element is not present, the corresponding neighboring cell may be a regular cell, i.e., a non-NES cell.

Listing 1

| | |
|---|---|
| SIB3 ::= | SEQUENCE { |
| intraFreqNeighCellList | IntraFreqNeighCellList |

OPTIONAL, -- Need R

| | |
|---|---|
| intraFreqExcludedCellList | IntraFreqExcludedCelList |

OPTIONAL, Need R

| | |
|---|---|
| lateNonCriticalExtension | OCTET STRING |

```
  OPTIONAL,
    ...,
    [[
```

| | |
|---|---|
| intraFreqNeighCellList-v1610 | IntraFreqNeighCellList-v1610 |

OPTIONAL, -- Need R

| | |
|---|---|
| intraFreqAllowedCellList-r16 | IntraFreqAllowedCellList-r16 |

OPTIONAL, -- Cond SharedSpectrum2

| | |
|---|---|
| intraFreqCAG-CellList-r16 | SEQUENCE (SIZE (1..maxPLMN)) OF IntraFreqCAG- |
| CellListPerPLMN-r16 | OPTIONAL -- Need R |

```
    ]],
    [[
```

| | |
|---|---|
| intraFreqNeighHSDN-CellList-r17 | IntraFreqNeighHSDN-CellList-r17 |

OPTIONAL, -- Need R

| | |
|---|---|
| intraFreqNeighCellList-v1710 | IntraFreqNeighCellList-v1710 |

```
  OPTIONAL -- Need R
    ]]
  }
```

| | |
|---|---|
| IntraFreqNeighCellList ::= | SEQUENCE (SIZE (1..maxCellIntra)) OF |

IntraFreqNeighCellInfo

| | |
|---|---|
| IntraFreqNeighCellList-v1610::= | SEQUENCE (SIZE (1..maxCellIntra)) OF |

IntraFreqNeighCellInfo-v1610

| | |
|---|---|
| IntraFreqNeighCellList-v1710 ::= | SEQUENCE (SIZE (1..maxCellIntra)) OF |

IntraFreqNeighCellInfo-v1710

| IntraFreqNeighCellInfo ::= | SEQUENCE { | |
|---|---|---|
| physCellId | PhysCellId, | |
| q-OffsetCell | Q-OffsetRange, | |
| q-RxLevMinOffsetCell | INTEGER (1..8) | OPTIONAL, -- |

Need R

| | | |
|---|---|---|
| q-RxLevMinOffsetCellSUL | INTEGER (1..8) | OPTIONAL, -- |

Need R

| | | |
|---|---|---|
| q-QualMinOffsetCell | INTEGER (1..8) | OPTIONAL, -- Need |

R

| | | |
|---|---|---|
| nesCellInfo | NesCellInfo | OPTIONAL, -- Need R |

...
}

| IntraFreqNeighCellInfo-v1610 ::= | SEQUENCE { | |
|---|---|---|
| ssb-PositionQCL-r16 | SSB-PositionQCL-Relation-r16 | OPTIONAL -- |

Cond SharedSpectrum2
}

| IntraFreqNeighCellInfo-v1710 ::= | SEQUENCE { | |
|---|---|---|
| ssb-PositionQCL-r17 | SSB-PositionQCL-Relation-r17 | OPTIONAL -- |

Cond SharedSpectrum2
}

| | |
|---|---|
| IntraFreqExcludedCellList ::= | SEQUENCE (SIZE (1..maxCellExcluded)) OF PCI-Range |
| IntraFreqAllowedCellList-r16 ::= | SEQUENCE (SIZE (1..maxCellAllowed)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}
IntraFreqNeighHSDN-CellList-r17 ::= SEQUENCE (SIZE (1..maxCellIntra)) OF PCI-Range

| SIB4 ::= | SEQUENCE { | |
|---|---|---|
| interFreqCarrierFreqList | InterFreqCarrierFreqList, | |
| lateNonCriticalExtension | OCTET STRING | OPTIONAL, |

```
  ...,
  [[
```

| | | |
|---|---|---|
| interFreqCarrierFreqList-v1610 | InterFreqCarrierFreqList-v1610 | OPTIONAL -- |

```
  Need R
  ]],
  [[
```

| | | |
|---|---|---|
| interFreqCarrierFreqList-v1700 | InterFreqCarrierFreqList-v1700 | OPTIONAL -- |

```
  Need R
  ]],
  [[
```

| | | |
|---|---|---|
| interFreqCarrierFreqList-v1720 | InterFreqCarrierFreqList-v1720 | OPTIONAL -- |

```
  Need R
  ]]
  }
```

| | |
|---|---|
| InterFreqCarrierFreqList ::= | SEQUENCE (SIZE (1..maxFreq)) OF |

```
  InterFreqCarrierFreqInfo
  InterFreqCarrierFreqList-v1610 ::= SEQUENCE (SIZE (1..maxFreq)) OF
  InterFreqCarrierFreqInfo-v1610
  InterFreqCarrierFreqList-v1700 ::= SEQUENCE (SIZE (1..maxFreq)) OF
  InterFreqCarrierFreqInfo-v1700
InterFreqCarrierFreqList-v1720 ::= SEQUENCE (SIZE (1..maxFreq)) OF
InterFreqCarrierFreqInfo-v1720
```

| | |
|---|---|
| InterFreqCarrierFreqInfo ::= | SEQUENCE { |
| dl-CarrierFreq | ARFCN-ValueNR, |
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | | |
|---|---|---|
| smtc | SSB-MTC | OPTIONAL, -- Need |

S

| ssbSubcarrierSpacing | SubcarrierSpacing, | |
|---|---|---|
| ssb-ToMeasure | SSB-ToMeasure | OPTIONAL, -- |

Need S

| | |
|---|---|
| deriveSSB-IndexFromCell | BOOLEAN, |
| ss-RSSI-Measurement | SS-RSSI-Measurement |

OPTIONAL, -- Need R

| q-RxLevMin | Q-RxLevMin, | |
|---|---|---|
| q-RxLevMinSUL | Q-RxLevMin | OPTIONAL, - |

- Need R

| | | |
|---|---|---|
| q-QualMin | Q-QualMin | OPTIONAL, -- |

Need S

| p-Max | P-Max | OPTIONAL, -- Need S |
|---|---|---|
| t-ReselectionNR | T-Reselection, | |
| t-ReselectionNR-SF | SpeedStateScaleFactors | OPTIONAL, |

-- Need S

| threshX-HighP | ReselectionThreshold, | |
|---|---|---|
| threshX-LowP | ReselectionThreshold, | |
| threshX-Q | SEQUENCE { | |
| threshX-HighQ | ReselectionThresholdQ, | |
| threshX-LowQ | ReselectionThresholdQ | |
| } | | OPTIONAL, -- Cond RSRQ |
| cellReselectionPriority | CellReselectionPriority | OPTIONAL, |

-- Need R

| | |
|---|---|
| cellReselectionSubPriority | CellReselectionSubPriority |

OPTIONAL, -- Need R

| | | |
|---|---|---|
| q-OffsetFreq | Q-OffsetRange | DEFAULT dB0, |
| interFreqNeighCellList | InterFreqNeighCellList | OPTIONAL, |

-- Need R

| | |
|---|---|
| interFreqExcludedCellList | InterFreqExcludedCellList |

OPTIONAL, -- Need R
...
}
InterFreqCarrierFreqInfo-v1610 ::= SEQUENCE {

| | |
|---|---|
| interFreqNeighCellList-v1610 | InterFreqNeighCellList-v1610 |

OPTIONAL, -- Need R

| | | |
|---|---|---|
| smtc2-LP-r16 | SSB-MTC2-LP-r16 | OPTIONAL, |

-- Need R

| | |
|---|---|
| interFreqAllowedCellList-r16 | InterFreqAllowedCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF InterFreqCAG- |

CellListPerPLMN-r16 OPTIONAL -- Need R
}
InterFreqCarrierFreqInfo-v1700 ::= SEQUENCE {

| | |
|---|---|
| interFreqNeighHSDN-CellList-r17 | InterFreqNeighHSDN-CellList-r17 |

OPTIONAL, -- Need R

| | |
|---|---|
| highSpeedMeasInterFreq-r17 | ENUMERATED {true} |

OPTIONAL, -- Need R

| | |
|---|---|
| redCapAccessAllowed-r17 | ENUMERATED {true} |

OPTIONAL, -- Need R

| | |
|---|---|
| ssb-PositionQCL-Common-r17 | SSB-PositionQCL-Relation-r17 |

OPTIONAL, -- Cond SharedSpectrum

| | |
|---|---|
| interFreqNeighCellList-v1710 | InterFreqNeighCellList-v1710 |

OPTIONAL -- Cond SharedSPectrum2
}
InterFreqCarrierFreqInfo-v1720 ::= SEQUENCE {

| | | |
|---|---|---|
| smtc4list-r17 | SSB-MTC4List-r17 | OPTIONAL -- |

Need R
}
InterFreqNeighHSDN-CellList-r17 ::= SEQUENCE (SIZE (1..maxCellInter)) OF PCI-Range

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) OF |

InterFreqNeighCellInfo-v1610

| | |
|---|---|
| InterFreqNeighCellList-v1710 ::= | SEQUENCE (SIZE (1..maxCellInter)) OF |

InterFreqNeighCellInfo-v1710

| InterFreqNeighCellInfo ::= | SEQUENCE { | |
|---|---|---|
| physCellId | PhysCellID, | |
| q-OffsetCell | Q-OffsetRange, | |
| q-RxLevMinOffsetCell | INTEGER (1..8) | OPTIONAL, |

-- Need R

| | |
|---|---|
| q-RxLevMinOffsetCellSUL | INTEGER (1..8) |

OPTIONAL, -- Need R

| | | |
|---|---|---|
| q-QualMinOffsetCell | INTEGER (1..8) | OPTIONAL, |

-- Need R

| | | |
|---|---|---|
| nesCellInfo | NesCellInfo | OPTIONAL, -- Need R |
| ... nesCellInfo | NesCellInfo | OPTIONAL, -- Need R |

}

| | |
|---|---|
| InterFreqNeighCellInfo-v1610 ::= | SEQUENCE { |
| ssb-PositionQCL-r16 | SSB-PositionQCL-Relation-r16 |

OPTIONAL -- Cond SharedSpectrum2
}

| | |
|---|---|
| InterFreqNeighCellInfo-v1710 ::= | SEQUENCE { |
| ssb-PositionQCL-r17 | SSB-PositionQCL-Relation-r17 |

OPTIONAL -- Cond SharedSpectrum2
}

| | |
|---|---|
| InterFreqExcludedCellList ::= | SEQUENCE (SIZE (1..maxCellExcluded)) OF PCI-Range |
| InterFreqAllowedCellList-r16 ::= | SEQUENCE (SIZE (1..maxCellAllowed)) OF PCI-Range |

InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}
NesCellInfo ::= SEQUENCE {

| | |
|---|---|
| nesType | ENUMERTED {SIB-less, SIB/SSB-less, spare, spare} |

...
}

The NES cell information in the neighboring cell information may be used in idle/inactive mode procedures, such as act 3-3 of FIG. 3. In a case that nesType of Listing 1 indicates that a neighboring cell is a SIB/SSB-less NES cell, the wireless terminal 30 may choose to derive the aforementioned synchronization information for the SIB/SSB-less NES cell from the anchor cell, specifically from the SSB of the anchor cell, e.g., access node 26A. The synchronization information may be accurately derived from the anchor cell when the SIB/SSB-less NES cell and the anchor cell are collocated. Depending on deployment scenarios, an anchor cell may not always be collocated with its associated NES cells. Therefore, the system information provided by the anchor cell may indicate such collocation relationship and/or may indicate whether the synchronization information can be derived from the anchor cell for each of the associated NES cells. As an exemplary implementation, Listing 1A shows an additional information field syncFromAnchor indicating that the derivation of the synchronization information from the anchor cell is allowed for the corresponding NES cell.

Listing 1A

| | |
|---|---|
| NesCellInfo ::= SEQUENCE { | |
| nesType | ENUMERTED {SIB-less, |
| SIB/SSB-less, spare, spare}, | |
| syncFromAnchor | ENUMERATED {allowed} |
| OPTIONAL, -- COND SSBless | |
| ... | |
| } | |

In a case that nesType indicates SIB/SSB-less, and syncFromAnchor is present, the wireless terminal of the present embodiment may consider that the corresponding NES cell is possibly collocated with the anchor cell and thus derive synchronization information from the anchor cell. If nesType indicates SIB/SSB-less, but syncFromAnchor is not present, then the wireless terminal may choose to use other means to derive the synchronization information, such as the method of on-demand SSB transmission disclosed in the example embodiment and mode of Section 4.0 hereof.

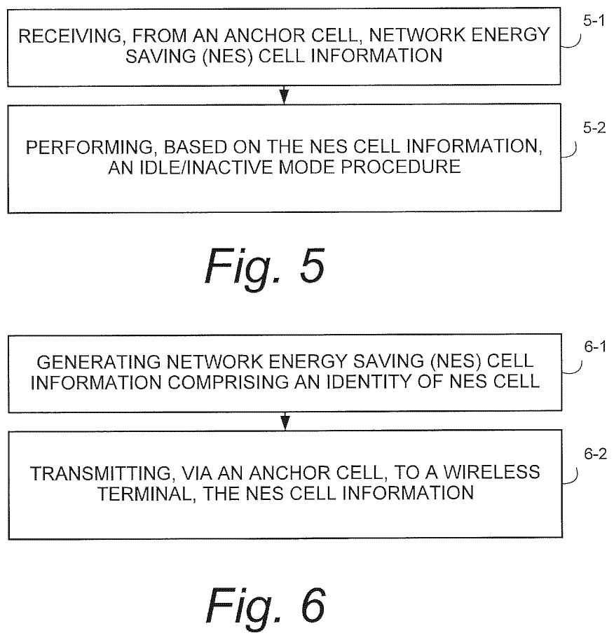

FIG. 5 shows basic example, representative acts or step performed by a wireless terminal of the example embodiment and mode of FIG. 4.

Act 5-1 comprises receiving, from an anchor cell, network energy saving (NES) cell information, which may comprise an identity of a NES cell associated with the anchor cell. The NES cell refrain from periodically transmitting broadcast signals for energy saving. The NES cell information may further comprise information indicating whether or not the NES cell broadcasts Synchronization Signal Block (SSB). Additionally, or alternatively, the NES cell information may further comprise information indicating whether or not the NES cell broadcasts system information.

Act 5-2 comprises performing, based on the NES cell information, an idle/inactive mode procedure. An example of such an idle/inactive mode procedure may be to derive synchronization information of the NES cell. In this example, the NES cell information may further comprise an indication indicating whether or not the anchor cell's SSB can be used to derive the synchronization information of the NES cell.

FIG. 6 shows basic example, representative acts or steps performed by an access node of the example embodiment and mode of FIG. 4.

Act 6-1 comprises generating network energy saving (NES) cell information comprising an identity of NES cell, for a NES cell that refrains from periodically transmitting broadcast signals for energy saving. The NES cell information may further comprise information indicating whether or not the NES cell broadcasts Synchronization Signal Block (SSB). Additionally, or alternatively, the NES cell information may further comprise information indicating whether or not the NES cell broadcasts system information. The NES cell information may be used by the wireless terminal to perform an idle/inactive mode procedure. An example of such an idle/inactive mode procedure may be to derive synchronization information of the NES cell. In this example, the NES cell information may further comprise an indication indicating whether or not the anchor cell's SSB can be used to derive the synchronization information of the NES cell.

Act 6-2 comprises transmitting, via an anchor cell, to a wireless terminal, the NES cell information.

### 2.0:System Information Acquisition for Network Energy Saving Cells

The technology disclosed in the example embodiments and modes of section 1.0 hereof concerns acquisition of system information required to access an intra-frequency or inter-frequency NES cell with SIB-less or SIB/SSB-less attribute. The system information for the NES cell may be acquired from an anchor cell. The technology of the example embodiments and modes of section 1.0 hereof concerns methods and apparatus for acquisition of the system information from an anchor cell, as represented by act 3-6 of FIG. 3, for example.

In accordance with an example aspect of the technology section 2.0, an anchor cell may broadcast the system information of associated NES cells, e.g., as a part of the anchor cell's own system information broadcast. The wireless terminal may acquire, from the anchor cell, such system information. That is, the wireless terminal may acquire, from the system information of the anchor cell, the system information for the NES cell. The acquired system information may be used for accessing a NES cell.

As shown in FIG. 2, in some example deployment scenarios, anchor cell 22 may be associated with more than one NES cells, such as cell 22B, cell 22C, and cell 22D. Since each of the associated NES cells may have system information contents different from the other NES cells. In such situation, the anchor cell may be required to broadcast a version of system information for each of the associated NES cells.

### 2.1: System Information Acquisition for Network Energy Saving Cells:Example Structure

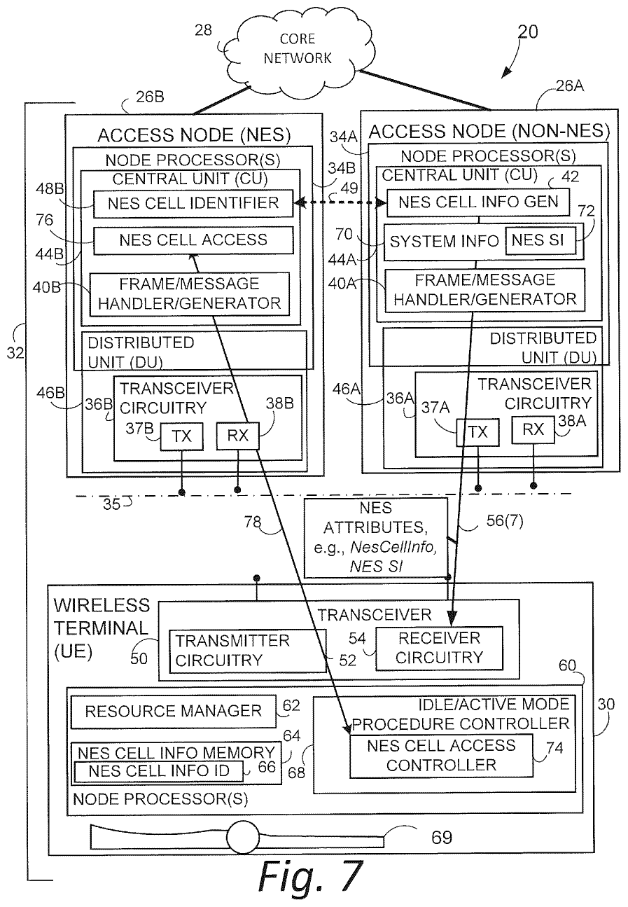

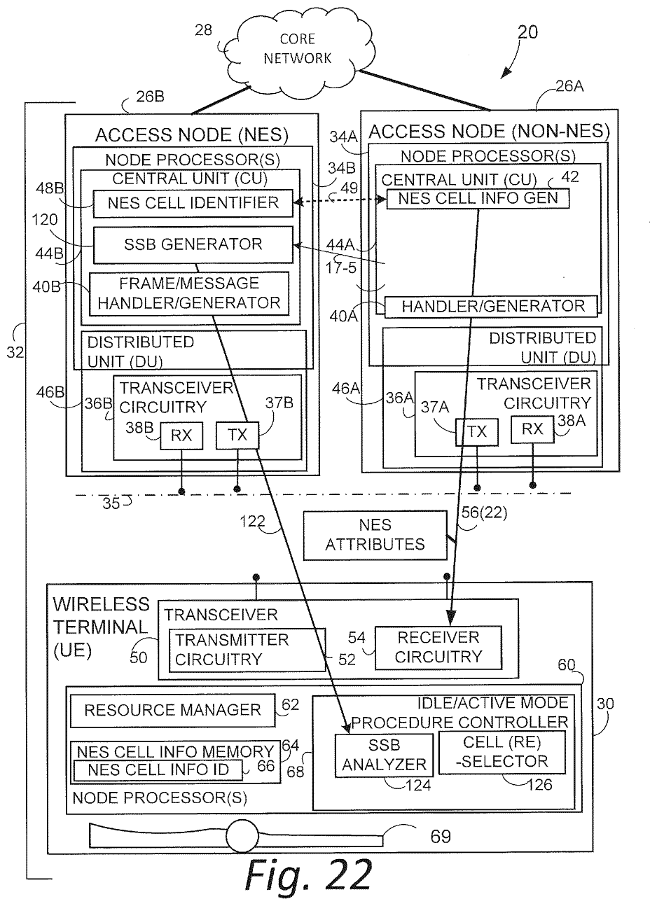

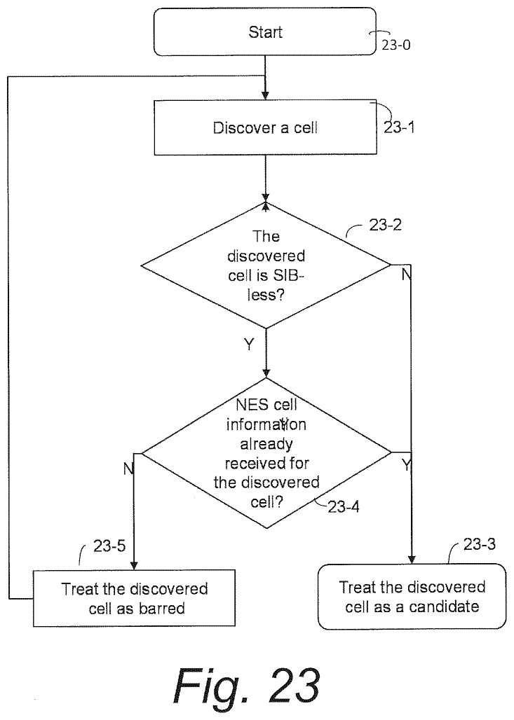

FIG. 7 shows, in generic manner, a communications network or system suitable for implementation of the technology of section 2.0 wherein system information for a NES cell is provided by an anchor cell, i.e., an anchor access node. The architectural and structure of the nodes and units shown in FIG. 7 is identical to FIG. 4 except as described herein or otherwise apparent. For example, except as otherwise described in section 2.0, the access node 26A and access node 26B of FIG. 7 have the same structure and operation as shown and described with reference to FIG. 4, and wireless terminal 30 has the same structure and operation as shown and described with reference to FIG. 4, regardless of whether the structural elements of such other example embodiments and modes are explicitly illustrated in FIG. 22, since some structural elements may not be again illustrated for sake of simplicity

A first example difference between the structure of FIG. 7 and FIG. 4 includes the access node processors 34 comprising system information generator 70. The system information generator 70 includes not only the system information for cell 22A served by access node 26A, but also the system information for NES cells associated with the anchor node access node 26A, such as cells 22B, 22C, and 22D of FIG. 2. Accordingly, system information generator 70 is shown in FIG. 7 as including or comprising or working in conjunction with NES system information generator/memory 72. The NES system information generator 72 may generate or store system information for any NES cell associated with the anchor access node 26A, such as NES cell 26B of FIG. 7.

In an example implementation of the embodiment and mode of FIG. 7, the system information of the NES cell 22B may be included in the system information of the anchor cell 22A which is transmitted from access node 26A to wireless terminal 30. The access node frame/message handler/generator 40A of access node 26A may thus prepare a message depicted by arrow 56(7) in FIG. 7 for transmission by access node transceiver circuitry 36A. The message depicted by arrow 56(7) in FIG. 7 includes not only information to identify the NES cell as described in conjunction with section 1.0 hereof, but also includes the system information of the NES cell, which is essential for accessing the NES cell, e.g., for accessing NES cell 22B.

A second example difference between the structure of FIG. 7 and FIG. 4 includes the wireless terminal processor(s) 60 of wireless terminal 30 as comprising terminal NES cell access controller 74 and access node 26B as comprising node NES cell access controller 76. The NES cell access controller 74 may comprise or work in conjunction with idle/active mode procedure controller 68, and thus may comprise or be included in wireless terminal processor(s) 60. The node NES cell access controller 76 may comprise or be included in access node processors 34B of access node 26B. Arrow 78 of FIG. 7 represents messages or signals that are transmitted between wireless terminal 30 and access node 26B as part of, e.g., included in, an access procedure for accessing cell 22B which is served by access node 26B.

Thus, the example embodiment and mode of FIG. 7 and section 2.0 concerns, e.g., a wireless terminal of a cellular telecommunication system which comprises receiver circuitry and processor circuitry. An example is wireless terminal 30 comprising terminal receiver circuitry 54 and wireless terminal processor(s) 60. The receiver circuitry is configured to receive, from an anchor cell, network energy saving (NES) cell information comprising: an identity of a NES cell associated with the anchor cell, and essential information. The essential information is or comprises information required to access the NES cell. The processor circuitry is configured to access the NES cell using the NES information.

The example embodiment and mode of FIG. 7 and section 2.0 concerns, e.g., an access node of a cellular telecommunication system that comprises processor circuitry and transmitter circuitry. An example is access node 26A comprising access node processors 34A and node transmitter circuitry 37A. The processor circuitry is configured to generate network energy saving (NES) cell information comprising: an identity of a NES cell associated with an anchor cell, and essential information. The essential information comprises information required to access the NES cell. The transmitter circuitry is configured to transmit, via an anchor cell, to a wireless terminal, the NES cell information.

### 2.1: System Information Acquisition for Network Energy Saving Cells:Example Operation

In one example implementation of an example embodiment and mode of the system of FIG. 7 and section 2.0, the system information contents per NES cell may be configured as a part of NesCellInfo of Listing 1A, as shown in Listing 1B.

Listing 1B

NesCellInfo ::= SEQUENCE {

| | |
|---|---|
| nesType | ENUMERTED {SIB-less, SIB/SSB-less, spare, |
| | spare}, |
| syncInfo | ENUMERATED {allowed} OPTIONAL, -- COND |
| | SSBless |

```
  systemInformationBlockType1 SIB1 OPTIONAL, -- COND SIBless
  systemInformation SystemInformation OPTIONAL, -- COND SIBless
```

| | | |
|---|---|---|
| ssbInfo | SSBInfo | OPTIONAL, -- COND SSBless |

...
}

In Listing 1B, the information element systemInformationBlockType1 may provide the SIB1 contents of the NES cell specified in the corresponding IntraFreqNeighCellInfo or InterFreqNeighCellInfo. In addition, the information element systemInfor-mationBlockType1 may be optionally present if NES-Type indicates the NES cell is SIB-less or SIB/SSB-less. The information element systemInformation may carry SIBs other than SIB1 for the NES cell. Furthermore, the information element ssbInfo may comprise information that the NES cell would provide within its SSB, such as all or a subset of elements in Master Information Block (MIB).

As an alternative implementation, the system information contents for the associated NES cells may be broadcasted by the anchor cell in one or more separate SIBs. For example, Listing 2 shows an example format of SIBx, a SIB broadcasted by the anchor cell, comprising the system information for the associated NES cells. The information element nesID may refer to one of the NES cells present in SIB3 or SIB4 of Listing 1. In one configuration, nesID may be a physical cell ID (PCI), wherein the IntraFreqNeighCellInfo or InterFreqNeighCellInfo instance with physCellID matching the nesID may be the one of the NES cells. In another configuration, nesID may be an index to one of the NES cells present in SIB3 or SIB4 of Listing 1.

Listing 2

| SIBx ::= SEQUENCE { | |
|---|---|
| nesSiCellInfoList SEQUENCE (SIZE (1..maxNesCells)) OF | |
| nesSiCellInfo, | |
| ... | |
| } | |
| nesSiCellInfo ::= | SEQUENCE { |
| nesID | NesID, |
| systemInformationBlockType1 | SIB1 |
| OPTIONAL, -- COND SIBless | |
| systemInformation | SystemInformation |
| OPTIONAL, -- COND SIBless | |
| ssbInfo | SSBInfo |

OPTIONAL, -- COND SSBless
}

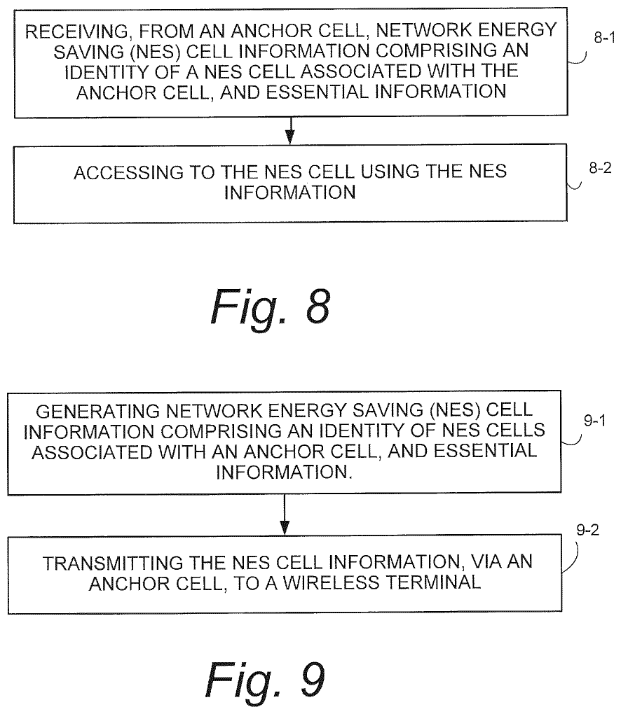

FIG. 8 shows example basic, representative steps or acts performed by a wireless terminal 30 of an example embodiment and mode of FIG. 7 and section 2.0 hereof.

Act 8-1 comprises receiving, from an anchor cell, network energy saving (NES) cell information comprising an identity of a NES cell associated with the anchor cell, and essential information. The essential information may be information required to access the NES cell. The essential information for the NES cell may comprise synchronization information, all or a subset of Master System Information (MIB), all or a subset of System Information Block Type 1 (SIB1), and/or all or a subset of Other SIBs.

Act 8-2 comprises accessing the NES cell using the NES information.

FIG. 9 shows example basic, representative steps or acts performed by an access node, such as access node 26B, of an example embodiment and mode of FIG. 7 and section 2.0 hereof.

Act 9-1 comprises generating network energy saving (NES) cell information comprising an identity of NES cells associated with an anchor cell, and essential information. The essential information may be or comprise information required to access the NES cell. The essential information may comprise synchronization information, all or a subset of Master System Information (MIB), all or a subset of System Information Block Type 1 (SIB1), and/or all or a subset of Other SIBs.

Act 9-2 comprises transmitting the NES cell information via an anchor cell to a wireless terminal.

### 3.0:on-Demand System Information for Network Energy Saving Cells

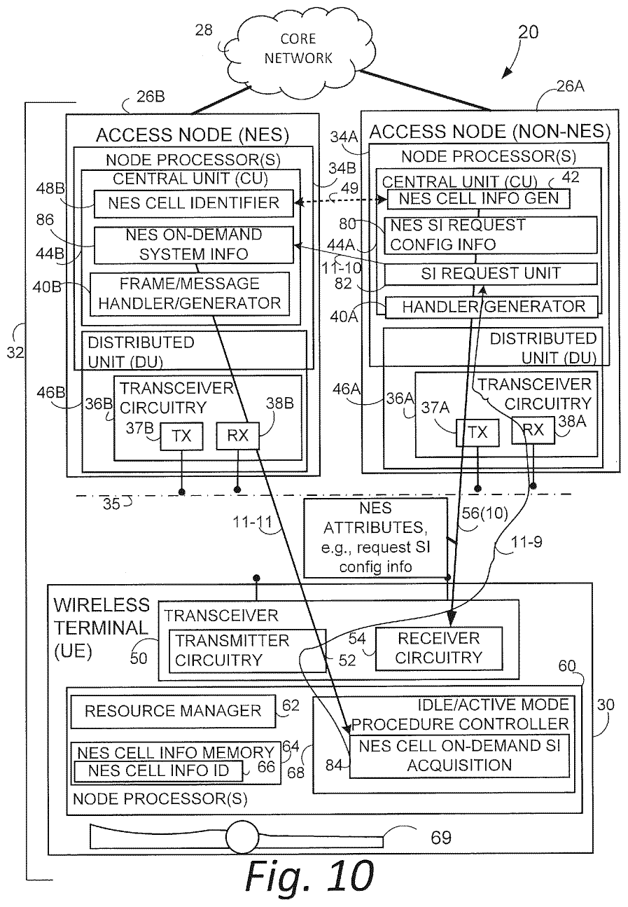

The example embodiment and mode of FIG. 7 and section 2.0 hereof discloses one configuration of an anchor cell that provides associated NES cell's system information. As described in section 3.0 and the example embodiments and modes represented by FIG. 10, additionally or alternatively, system information of a NES cell may be provided by the NES cell with or according to an on-demand basis. In doing so, the transmission of system information for the NES cell can be limited to transmission of system information only when necessary, rather than being periodic without regard to actual need of the system information for the NES cell. Provisioning of system information by on-demand basis may apply to NES cells for which their associated anchor cell does not provide the system information as a part of NesCellInfo shown in Listing 1B or Listing 1C (i.e., systemInformationBlockType1 and/or systemInformation is absent).

### 3.1: On-Demand System Information for Network Energy Saving Cells: Example Structure

FIG. 10 shows, in generic manner, a communications network or system suitable for implementation of the technology of section 3.0 wherein system information is provided on-demand for a NES cell. The architectural and structure of the nodes and units shown in FIG. 10 is identical to FIG. 4 and FIG. 7 except as described herein or otherwise apparent. For example, except as otherwise described in section 3.0, the access node 26A and access node 26B of FIG. 10 have the same structure and operation as shown and described with reference to FIG. 4 and FIG. 7, and wireless terminal 30 has the same structure and operation as shown and described with reference to FIG. 4 and FIG. 7, regardless of whether the structural elements of such other example embodiments and modes are explicitly illustrated in FIG. 22, since some structural elements may not be again illustrated for sake of simplicity.

A first example difference between the structure of FIG. 10 and previously described example embodiments and modes includes the access node processors 34 comprising NES system information (SI) request configuration generator 80 and system information request coordinator 82, also shown as SI request unit 82. The NES system information (SI) request configuration information, which is generated by generator 80, is configured for use by the wireless terminal so that the wireless terminal may send, to the anchor cell, a request message for the on-demand system information.

The NES system information (SI) request configuration generator 80, like the system information generator 70 includes at least some, but not necessarily all, of the system information for NES cells associated with the anchor node access node 26A, such as cells 22B, 22C, and 22D of FIG. 2. Although not shown as such in FIG. 10, NES system information (SI) request configuration generator 80 also may include, comprise, or work in conjunction with NES system information generator 72.

In an example implementation of the embodiment and mode of FIG. 10, some of the system information of the NES cell 22B and the NES system information (SI) request configuration information generated by NES system information (SI) request configuration generator 80 may be included in a message depicted by arrow 56(10) in FIG. 10 for transmission by access node transceiver circuitry 36A.

A second example difference between the structure of FIG. 10 and the previous example embodiments and modes of FIG. 4 and FIG. 7 includes the wireless terminal processor(s) 60 of wireless terminal 30 as comprising NES cell on-demand system information acquisition controller 84. The NES cell on-demand system information acquisition controller 84 may comprise or work in conjunction with idle/active mode procedure controller 68, and thus may comprise or be included in wireless terminal processor(s) 60.

A third example difference between the structure of FIG. 10 and the previous example embodiments and modes of FIG. 4 and FIG. 7 includes access node processors 34 of NES access node 26B as comprising NES cell on-demand system information provision controller 86. The NES cell on-demand system information provision controller 86 may generate the demanded system information for transmission by access node transceiver circuitry 36B to wireless terminal 30.

Thus, an example embodiment and mode of FIG. 10 and section 3.0 concerns, e.g., a wireless terminal of a cellular telecommunication system which comprises receiver circuitry processor circuitry, and transmitter circuitry. A non-limiting, representative example is wireless terminal 30 of FIG. 10 comprising wireless terminal processor(s) 60 and terminal receiver circuitry 54. The receiver circuitry is configured to receive, from an anchor cell, network energy saving (NES) cell information comprising: an identity of a NES cell associated with the anchor cell and NES system information (SI) request configuration information configuring on-demand system information to be broadcasted by the NES cell. The processor circuitry is configured to generate, based on the NES SI request configuration information, a request message for the on-demand system information. The transmitter circuitry is configured to transmit, to the anchor cell, the request message.

An example embodiment and mode of FIG. 10 and section 3.0 concerns, e.g., an access node of a cellular telecommunication system that comprises processor circuitry and transmitter circuitry. A non-limiting, representative example is access node 26A comprising access node processors 34A and node transmitter circuitry 37A. The processor circuitry is configured to generate network energy saving (NES) cell information comprising: an identity of a NES cell associated with an anchor cell; and NES system information (SI) request configuration information configuring on-demand system information to be broadcasted by the NES cell. The NES cell information is configured for use by a wireless terminal to send, to the anchor cell, a request message for the on-demand system information. The transmitter circuitry is configured to transmit the NES cell information via the anchor cell to the wireless terminal.

### 2.2: On-Demand System Information for Network Energy Saving Cells:Example Operation

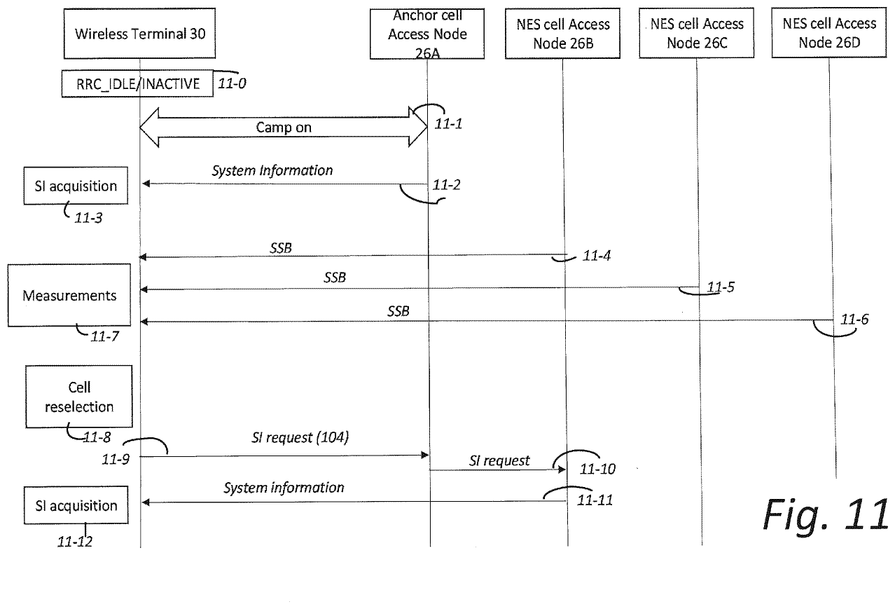

FIG. 11 illustrates an exemplary scenario of basic acts or steps for the example embodiment and mode of FIG. 10 and section 3.0, wherein the associated NES cells are SIB-less, e.g., the associated NES cells do not periodically broadcast their system information blocks.

Consistent with act 3-1 of FIG. 3, and as act 11-0 of FIG. 11, the wireless terminal 30 is in RRC_IDLE or RRC_INACTIVE state and camps on the anchor cell 102a, as depicted by act 11-1. As act 11-2, access node 26A of anchor cell 22A may broadcast system information including NES cell information, such as SIB3/SIB4 disclosed in the example embodiments and modes of section 2.0 hereof. In the scenario of FIG. 11, the NES cell information may indicate that cell 22B, cell 22C and cell 22D are SIB-less NES cells associated with anchor cell 22A. Act 11-2 may also be represented by arrow 56(10) of FIG. 11.

As act 11-3, wireless terminal 30 may acquire the system information from access node 26A of cell 22A, which is also understood with reference to act 3-2 of FIG. 3. The access nodes of the associated NES cells, i.e., cell 22B, cell 22C, and cell 22D, may periodically broadcast Synchronization Signal Blocks, SSBs, as shown in act 11-4, act 11-5 and act 11-6, respectively.

Based on the system information which the wireless terminal 30 acquired in act 11-3, as wireless terminal 30 may execute act 3-4 of FIG. 3 to scan frequencies instructed by the SIB3/SIB4 and thereby, as act 11-4, perform measurements. The measurements may involve evaluating strength of SSBs from neighboring cells, including the associated NES cells. Based on the results of the measurements, as act 11-8 the wireless terminal 30 may make a decision to reselect one of the measured cells.

If the cell reselected in act 11-8 is one of the NES cells configured in the system information of act 11-2, as act 11-9 the wireless terminal 30 may send, to anchor cell 102, an SI request to request on-demand delivery of system information for the one of the NES cells. The SI request of act 11-9 may be forwarded to the SI request unit 82 of access node 26A. In the scenario of FIG. 11, NES cell 22B is assumed to be the reselected cell. The SI request of act 11-9, also illustrated in FIG. 10, may indicate an identity of NES cell 22B.

As act 11-10, illustrated both in FIG. 10 and FIG. 11, the SI request of act 11-9 may be forwarded, e.g., by SI request unit 82, from the access node 26A of anchor cell 22A to the access node 26B for NES cell 22B (Act 11-10). The SI request forwarded in act 11-10 may be received by NES cell on-demand system information provision controller 86. Receipt of the SI request of act 11-10 will trigger transmission of the requested system information from the access node 26B of NES cell 22B, shown as act 11-11 in both FIG. 10 and FIG. 11 to the NES cells, e.g., to access node 26B.

Based on the decision for the cell reselection in act 11-8 and receipt of the system information of the requested NAS cell 22B as shown by act 11-11, wireless terminal 30 may synchronize to NES cell 22B and, as act 11-12, acquire from NES cell 22B the system information. After the acquisition of the system information of cell 22B from access node 26B, wireless terminal 30 may proceed to establishing a connection to the network.

The resource information, such as periodicity, of the system information transmitted in Act 11-11 may be provided by the SSB received in Act 11-4. In addition, the system information of a NES cell provided on-demand (Act 11-11) may preferably comprise SIB1, and this SIB1 may indicate resource information of other SIBs (SIB2, SIB3, . . . ) of the NES cell. Transmission of such other SIBs of the NES cell may also be triggered by the SI request message of Act 11-9. In this case, wireless terminal may first acquire SIB1 from the NES cell, and then proceed to acquiring some of the other SIBs based on the resource information in the acquired SIB1.

In the example embodiment and mode of FIG. 10 and FIG. 11 and section 3.0, the system information of the anchor cell 22A whose transmission is depicted in Act 11-2 of FIG. 11 and message 56(10) of FIG. 10 may further comprise NES SI request configuration information, which instructs the wireless terminal how to request on-demand SI broadcast for a NES cell(s) in Act 11-9. Two approaches of obtaining and utilizing the NES SI request configuration information are presented herein: (1) a 2-step approach and (2) a 4-step approach.

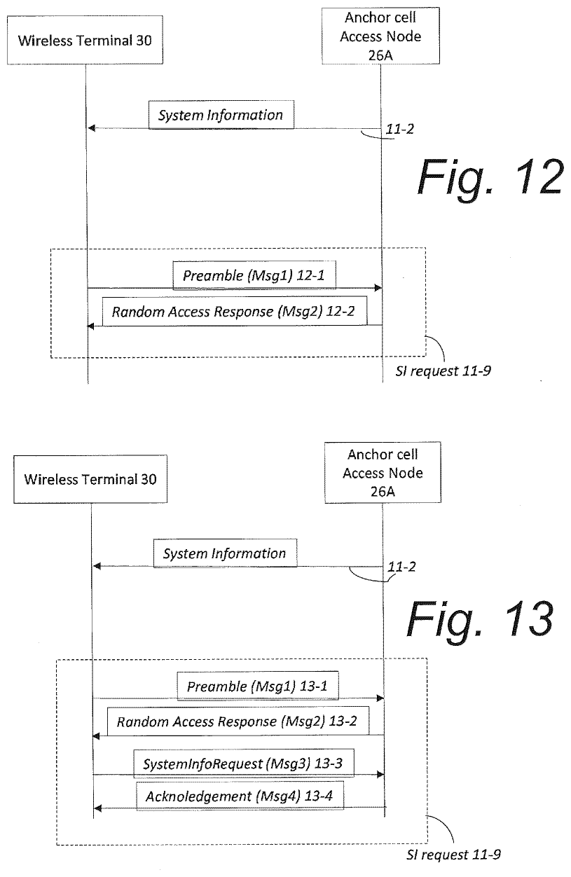

FIG. 12 illustrates one example configuration for the system information request for the 2-step approach, comprising 2 sub-steps (Msg1 and Msg2). Sub-step 12-1 may comprise wireless terminal's transmission of a Random Access (RACH) preamble. The transmission of the preamble may indicate at least one identity of an NES cell, e.g., the identity of NES cell 102B in the scenario of FIG. 11, by using a preamble sequence and uplink radio resources. For this configuration, the system information acquired from anchor cell 22A in Act 11-2 may further configure a designated preamble sequence(s) and/or designated uplink radio resources for each of the associated NES cells. Sub-step 12-2 may comprise a Random Access Response (RAR) to acknowledge to Msg1.

FIG. 13 depicts another example configuration of the system information request for the 4-step approach, comprising 4 sub-steps (Msg 1, Msg2, Msg3 and Msg4). Sub-step 13-1 comprises transmission of a RACH preamble, similar to the RACH preamble of Sub-step 12-1. However, herein the RACH preamble sequence of Sub-step 13-1 may not indicate any NES cell for which wireless terminal 30 requests system information, and thus has no designation to a specific NES cell. Sub-step 13-2 comprises a random access request, RAR, for the RACH preamble transmission of Sub-step 13-1. Based on the RAR, in Sub-step 13-3, wireless terminal 30 may proceed to transmitting SystemInfoRequest message (Msg3), comprising at least one identity of an NES cell, e.g., the identity of NES cell 22B in the scenario of FIG. 11. The system information request message may be acknowledged by the access node 26A of anchor cell 22A in Sub-step 13-4.

Listing 3 shows an example format of information in the anchor cell's system information to configure the system information request, shown in FIG. 12 and FIG. 13. Preferably, the information element SI-SchedulingInfo may be broadcasted as a part of the anchor cell's SIB1. The information element SI-SchedulingInfo may include si-RequestConfigNES, which may be optionally present if the configuration of FIG. 12 is to be used, otherwise the configuration of FIG. 13 may be used. The information element RequestConfigNES may indicate the RACH preamble and resources designated for one or more of the associated NES cells, identified by nesIDs, as disclosed above.

Listing 3

-- ASN1START
-- TAG-SI-SCHEDULINGINFO-START

| | |
|---|---|
| SI-SchedulingInfo ::= | SEQUENCE { |
| schedulingInfoList | SEQUENCE (SIZE (1..maxSI- |

Message)) OF SchedulingInfo,

| | |
|---|---|
| si-WindowLength | ENUMERATED {s5, s10, s20, s40, |

s80, s160, s320, s640, s1280, s2560-v1710, s5120-v1710 },

| | |
|---|---|
| si-RequestConfig | SI-RequestConfig |

OPTIONAL, -- Cond MSG-1

| | |
|---|---|
| si-RequestConfigSUL | SI-RequestConfig |

OPTIONAL, -- Cond SUL-MSG-1

| | |
|---|---|
| systemInformationAreaID | BIT STRING (SIZE (24)) |

OPTIONAL, -- Need R

| | |
|---|---|
| si-RequestConfigNES | RequestConfigNES OPTIONAL, |

-- Cond MSG-1
...
}

| | |
|---|---|
| RequestConfigNES ::= | SEQUENCE { |
| rach-Occasions | SEQUENCE { |
| rach-Config | RACH-ConfigGeneric, |
| ssb-perRACH-Occasion | ENUMERATED {oneEighth, |

oneFourth, oneHalf, one, two, four, eight, sixteen}
}
OPTIONAL, -- Need R

| | |
|---|---|
| RequestPeriod | ENUMERATED {one, two, |
| | four, |
| six, eight, ten, twelve, sixteen} | OPTIONAL, -- Need R |
| RequestResources | SEQUENCE (SIZE |

(1..maxNESCells)) OF RequestResourcesNES
}

| | |
|---|---|
| RequestResources ::= | SEQUENCE { |
| nesCells | SEQUENCE (SIZE |
| (1..maxNESCells)) of NesID | OPTIONAL, -- Need R |
| ra-PreambleStartIndex | INTEGER (0..63), |
| ra-AssociationPeriodIndex | INTEGER (0..15) |

OPTIONAL, -- Need R

| | |
|---|---|
| ra-ssb-OccasionMaskIndex | INTEGER (0..15) |

OPTIONAL -- Need R
}

Listing 4 shows an example format of the SystemInfoRequest message in Sub-step 8-3, which will be used in a case that RequestConfigNES is not present in SI-SchedulingInfo of Listing 4. The message may at least comprise one or more NesIDs to identify NES cells that on-demand transmission of system information is being requested.

Listing 4

| SystemInfoRequest::=SEQUENCE { | |
|---|---|
| nesCells | SEQUENCE (SIZE (1..maxNESCells)) of NesID, |

...
}

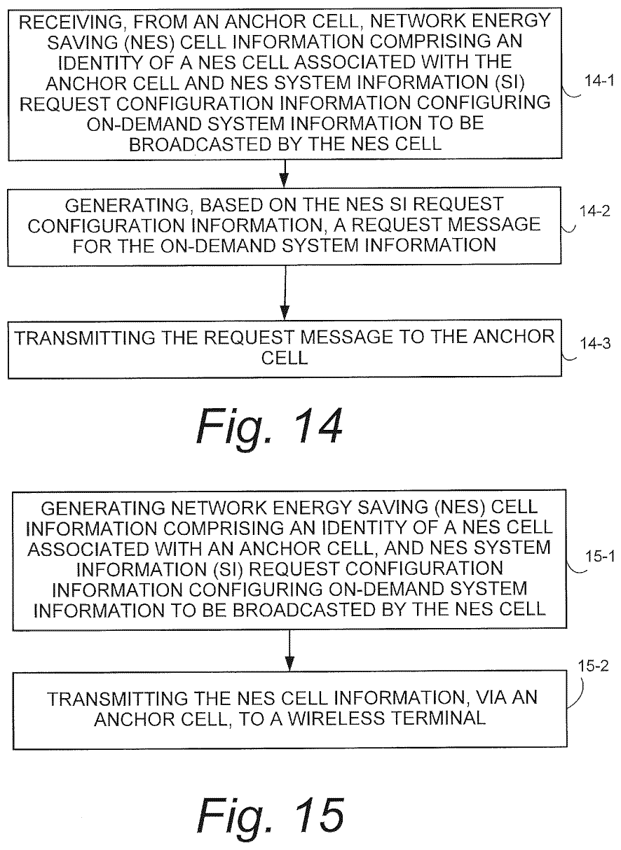

FIG. 14 is a flow chart showing example representative steps or acts performed by an example embodiment and mode of a wireless terminal, such as wireless terminal 30 of the example embodiment and mode of FIG. 10 and FIG. 11 and section 3.0.

Act 14-1 comprises receiving, from an anchor cell, network energy saving (NES) cell information comprising an identity of a NES cell associated with the anchor cell and NES system information (SI) request configuration information configuring on-demand system information to be broadcasted by the NES cell. The NES SI request configuration information may configure one or more Random Access Channel (RACH) preambles and one or more RACH resources designated for the request message.

Act 14-2 comprises generating, based on the NES SI request configuration information, a request message for the on-demand system information. The request message comprises the identity of the NES cell.

Act 14-3 comprises transmitting the request message to the anchor cell. The wireless terminal may receive, based on the request message, from the NES cell, the on-demand system information. The on-demand system information may include System Information Block Type 1 (SIB1).

FIG. 15 is a flow chart showing example representative steps or acts performed by an access node, such as access node 26A, of an example embodiment and mode of FIG. 10 and FIG. 11 and section 3.0.

Act 15-1 comprises generating network energy saving (NES) cell information comprising an identity of a NES cell associated with an anchor cell, and NES system information (SI) request configuration information configuring on-demand system information to be broadcasted by the NES cell. The NES SI request configuration information may configure one or more Random Access Channel (RACH) preambles and one or more RACH resources designated for the request message.

Act 15-2 comprises transmitting the NES cell information via the anchor cell to a wireless terminal. The NES cell information may be used by the wireless terminal to send, to the anchor cell, a request message for the on-demand system information. The request message may comprise the identity of the NES cell. The access node may receive, via the anchor cell, from the wireless terminal, the request message, which will cause the access node to instruct the NES cell to transmit the on-demand system information. The on-demand system information may include System Information Block Type 1 (SIB1).

### 4.0: On-Demand SSB Transmission for Network Energy Saving Cells

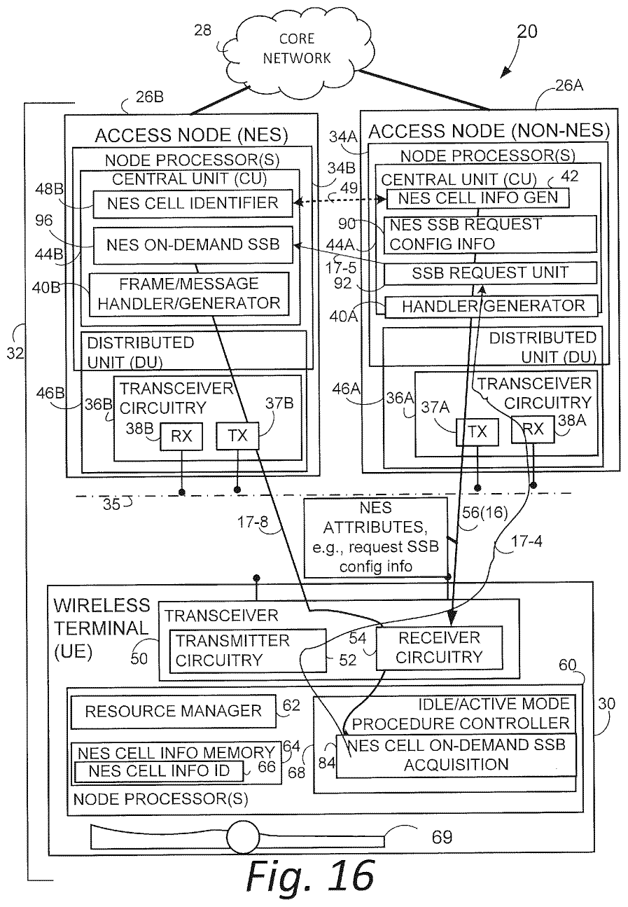

The example embodiments and modes of FIG. 10 and FIG. 11 and section 30 hereof describe, e.g., an anchor cell providing an associated NES cell's system information based on an on-demand request. The scenario shown in FIG. 11 assumes that the associated NES cells are SIB-less cells but do transmit SSBs. As mentioned above, NES cells in some deployment scenarios may also refrain from transmitting SSBs for further energy saving, and are referred to as “SIB/SSB-less cells”. In some scenarios for SIB/SSB-less cells, some information, such as synchronization timing and MIB may be provided by the anchor cell. However, lack of SSBs from the NES cells may offer no opportunities to a wireless terminal camping on the anchor cell to perform measuring the NES cells and determine which NES cell to reselect/access to. Thus, there may be a need for the SIB/SSB-less cells to broadcast SSBs when necessary. The example embodiments and modes of FIG. 16 and section 4.0 hereof disclose method and apparatus for on-demand transmission of SSBs from the NES cells.

### 4.1: On-Demand SSB Transmission for Network Energy Saving Cells: Example Structure

FIG. 16 shows, in generic manner, a communications network or system suitable for implementation of the technology of section 4.0 wherein Synchronization Signal Block (SSB) information is provided on-demand for a NES cell. The architectural and structure of the nodes and units shown in FIG. 16 are identical to FIG. 10, as well as FIG. 4 and FIG. 7, except as described herein or otherwise apparent. For example, except as otherwise described in section 4.0, the access node 26A and access node 26B of FIG. 16 have the same structure and operation as shown and described with reference to FIG. 4, FIG. 7, and FIG. 10, and wireless terminal 30 of FIG. 16 has the same structure and operation as shown and described with reference to FIG. 4, FIG. 7, and FIG. 10, regardless of whether the structural elements of such other example embodiments and modes are explicitly illustrated in FIG. 22, since some structural elements may not be again illustrated for sake of simplicity.

A first example difference between the structure of FIG. 16 and previously described example embodiments and modes such as FIG. 10 includes the access node processors 34 comprising NES Synchronization Signal Block (SSB) request configuration generator 90 and Synchronization Signal Block (SSB) request coordinator 92, also shown as SSB request unit 92. The NES Synchronization Signal Block (SSB) request configuration information, which is generated by generator 90, is configured for use by the wireless terminal so that the wireless terminal may send, to the anchor cell, a request message for the on-demand Synchronization Signal Block (SSB) information.

The NES SSB request configuration generator 90, like the system information generator 70 and NES system information (SI) request configuration generator 80, may include at least some, but not necessarily all, of the system information for NES cells associated with the anchor node access node 26A, such as cells 22B, 22C, and 22D of FIG. 2. Although not shown as such in FIG. 16, NES SSB request configuration generator 90 also may include, comprise, or work in conjunction with NES system information generator 72.

In an example implementation of the embodiment and mode of FIG. 16, some of the system information of the NES cell 22B and the NES SSB request configuration information generated by NES SSB request configuration generator 90 may be included in a message depicted by arrow 56(16) in FIG. 16 for transmission by access node transceiver circuitry 36A.

A second example difference between the structure of FIG. 16 and the previous example embodiments and modes of FIG. 4, FIG. 7, and FIG. 10 includes the wireless terminal processor(s) 60 of wireless terminal 30 as comprising terminal NES cell on-demand SSB acquisition controller 94. The NES cell on-demand SSB acquisition controller 94 may comprise or work in conjunction with idle/active mode procedure controller 68, and thus may comprise or be included in wireless terminal processor(s) 60.

A third example difference between the structure of FIG. 16 and the previous example embodiments and modes of FIG. 4 and FIG. 7 and FIG. 10 includes access node processors 34B of NES access node 26B as comprising NES cell on-demand SSB provision controller 96. The NES cell on-demand SSB provision controller 96 may generate the demanded Synchronization Signal Block (SSB) information for transmission by access node transceiver circuitry 36B to wireless terminal 30.

Thus, the example embodiment and mode of FIG. 16 and section 4.0 hereof concerns, e.g., a wireless terminal of a cellular telecommunication system which comprises receiver circuitry processor circuitry, and transmitter circuitry. A non-limiting, representative example is wireless terminal 30 of FIG. 16 which comprises wireless terminal processor(s) 60 and terminal receiver circuitry 54. The receiver circuitry is configured to receive, from an anchor cell, network energy saving (NES) cell information comprising an identity of a NES cell associated with the anchor cell and NES Synchronization Signal Block (SSB) request configuration information configuring on-demand SSBs to be transmitted by the NES cell. The processor circuitry is configured to generate, based on the NES SSB request configuration information, a request message for the on-demand SSBs. The transmitter circuitry is configured to transmit the request message to the anchor cell.

The example embodiment and mode of FIG. 16 and section 4.0 hereof concerns, e.g., an access node of a cellular telecommunication system that comprises processor circuitry and transmitter circuitry. A non-limiting, representative example is access node 26A comprising access node processors 34A and node transmitter circuitry 37A. The processor circuitry is configured to generate network energy saving (NES) cell information comprising an identity of a NES cell associated with an anchor cell and NES Synchronization Signal Block (SSB) request configuration information configuring on-demand SSBs to be transmitted by the NES cell. The NES cell information is configured for used by the wireless terminal to send, to the anchor cell, a request message for the on-demand SSBs. The transmitter circuitry is configured to transmit, via the anchor cell, to a wireless terminal, the NES cell information.

### 4.2: On-Demand SSB Transmission for Network Energy Saving Cells:Example Operation

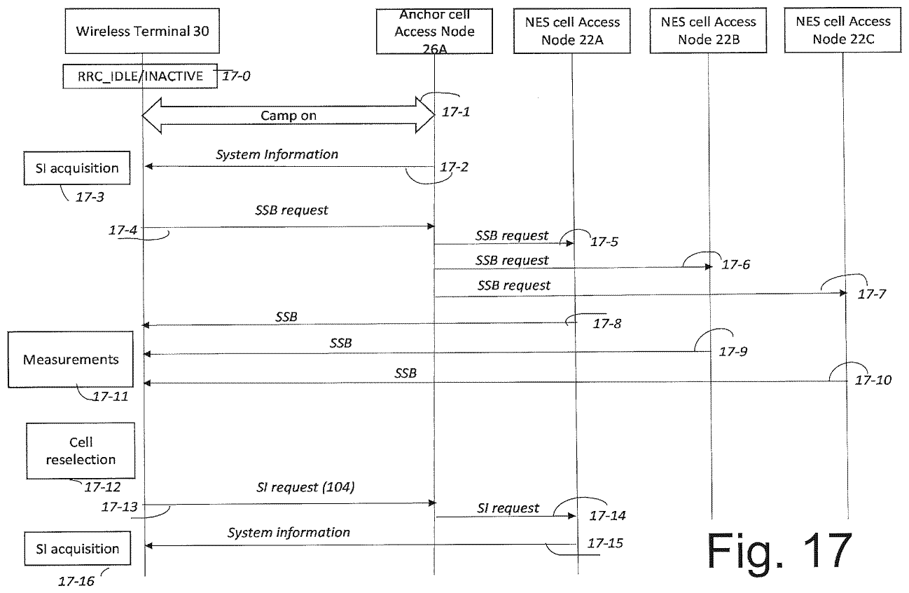

FIG. 17 illustrates an exemplary scenario for the example embodiment and mode of FIG. 16 and section 4.0. Act 17-0 and act 17-1 are identical to act 11-0 and act 11-1 of FIG. 11, respectively. In act 17-2, the access node 26A of anchor cell 22A may broadcast system information including NES cell information, such as SIB3/SIB4 disclosed in the previous embodiments. In the scenario of FIG. 17, the NES cell information may indicate that cell 22B, cell 22C, and cell 22D are SIB/SSB-less NES cells associated with anchor cell 22A and anchor access node 26A. The wireless terminal 30 may acquire the system information in act 17-3, in similar manner as in act 3-2 of FIG. 3.

Knowing that the associated NES cells are SIB/SSB-less NES cells, as act 17-4 illustrated in both FIG. 16 and FIG. 17, wireless terminal 30 may send an SSB request to the access node 26A which serves anchor cell 22A. The SSB request of act 17-4 may be forwarded to and handled by SI request unit 82. The access node 26A of anchor cell 22A may select all or some of the associated NES cells and forward the SSB request to an access node of each of the selected NES cells as shown in act 17-5, act 17-6 and act 17-6. The forwarding of the SBB request of act 17-5 to access node 26B is also illustrated in FIG. 16. The forwarded SSB requests may trigger transmission of SSBs from the access node 26B of NES cell 22B, the access node 26C of NES cell 22C, and the access node 26D of NES cell 22D, as shown in act 17-8, act 17-9 and act 17-10, respectively. In the case of NES cell 22B of FIG. 16, the forwarded SSB request of act 17-5 is received and handled by NES cell on-demand SSB provision controller 96, which generates the requested SSB for transmission via access node transceiver circuitry 36B to wireless terminal 30 as shown by act 17-8 in FIG. 16. Act 17-11 to act 17-16 are identical to Act 11-8 to Act 11-12 of FIG. 11, respectively.

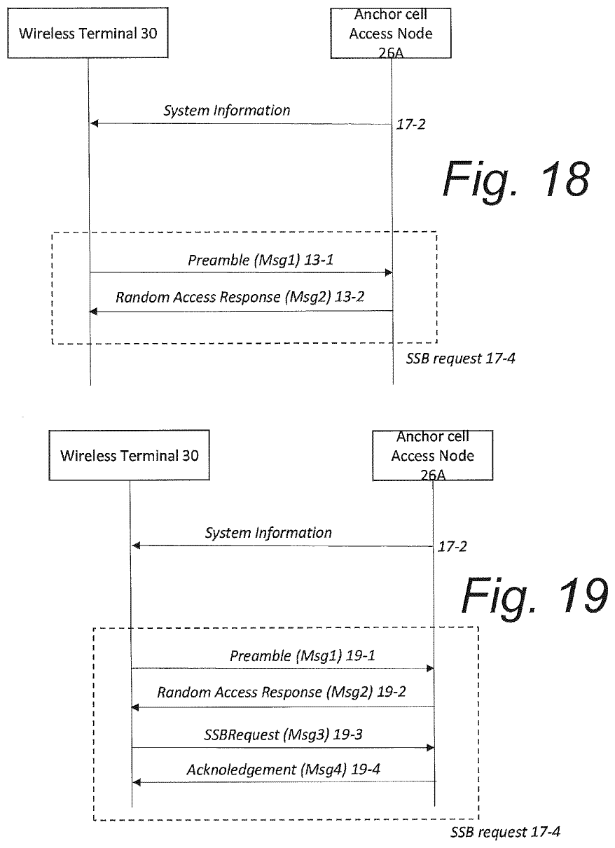

The SSB request of Act 17-4 may comprise several sub-steps. FIG. 18 shows one configuration using a 2-step RACH procedure, which is identical to FIG. 12, except that Msg1 of FIG. 18 may carry the SSB request. FIG. 19 shows another configuration using a 4 step RACH procedure which is identical to FIG. 13, except that Msg3 of FIG. 19 may carry the SSB request.

Listing 5 shows an example format of information in the anchor cell's system information to configure the SSB request, shown in FIG. 18 and FIG. 19. Preferably, the information element SI-SchedulingInfo may be broadcasted as a part of the anchor cell's SIB1. The information element SI-SchedulingInfo may include ssb-RequestConfigNES, which may be optionally present if the configuration of FIG. 18 is to be used, otherwise the configuration of FIG. 19 may be used. The format of ssb-RequestConfigNES may be identical to RequestConfigNES shown in Listing 3, to specify the RACH preamble and resources designated for the SSB request.

Listing 5

| -- ASN1START | |
|---|---|
| -- TAG-SI-SCHEDULINGINFO-START | |
| SI-SchedulingInfo ::= | SEQUENCE { |
| schedulingInfoList | SEQUENCE (SIZE |
| (1..maxSI-Message)) OF SchedulingInfo, | |
| si-WindowLength | ENUMERATED {s5, s10, |
| s20, s40, s80, s160, s320, s640, s1280, s2560-v1710, s5120- | |
| v1710 }, | |
| si-RequestConfig | SI-RequestConfig |
| OPTIONAL, -- Cond MSG-1 | |
| si-RequestConfigSUL | SI-RequestConfig |
| OPTIONAL, -- Cond SUL-MSG-1 | |
| systemInformationAreaID | BIT STRING (SIZE (24)) |
| OPTIONAL, -- Need R | |
| si-RequestConfigNES | RequestConfigNES |
| OPTIONAL, -- Cond MSG-1 | |
| ssb-RequestConfigNES | RequestConfigNES |

OPTIONAL, -- Cond MSG-1
...
}

Listing 6 shows an example format of the SSBRequest message in Sub-step 19-3, which will be used in a case that ssb-RequestConfigNES is not present in SI-SchedulingInfo of Listing 5.

Listing 6

| | |
|---|---|
| SSBRequest ::= | SEQUENCE { |
| nesCells | SEQUENCE (SIZE |
| (1..maxNESCells)) of NesID | OPTIONAL, |

...
}

As implied in FIG. 17, wireless terminal 30 may have knowledge of the NES cells associated with anchor cell 22A but may not know which NES cells are more suitable to reselect/access, until it performs measurements, such as act 17-11. Thus, wireless terminal may not specify identities of NES cells in the SSB request of act 17-4, which may lead to the optional field nesCells in ssb-RequestConfigNES of Listing 5 or in SSBRequest of Listing 6 being absent. In this case anchor cell 22A may select all the associated NES cells or a subset of the associated NES cells for SSB transmission. The subset may be chosen based on various factors, which may include, but not limited to, downlink and/or uplink beam information detected in the RACH procedure shown in FIG. 18 or FIG. 19.

In addition, the scenario in FIG. 17 shows one configuration where the SSB request, e.g., act 17-4) and the SI request, act 17-13, are separate and/or independent. In another configuration, the SSB request may also serve as the SI request. That is, when receiving the SSB request, anchor cell 22A may request the selected NES cells for system information broadcast, in addition to SSB transmission. In this configuration, wireless terminal 30 may not need to perform the SI request of act 17-13. Whether or not the SSB request also serves as an SI request may be pre-determined, pre-configured or network-configured to wireless terminal 30. In the case of network-configured, SI-SchedulingInfo of Listing 5 may have an additional indication to indicate whether the SSB request also serves as an SI request.

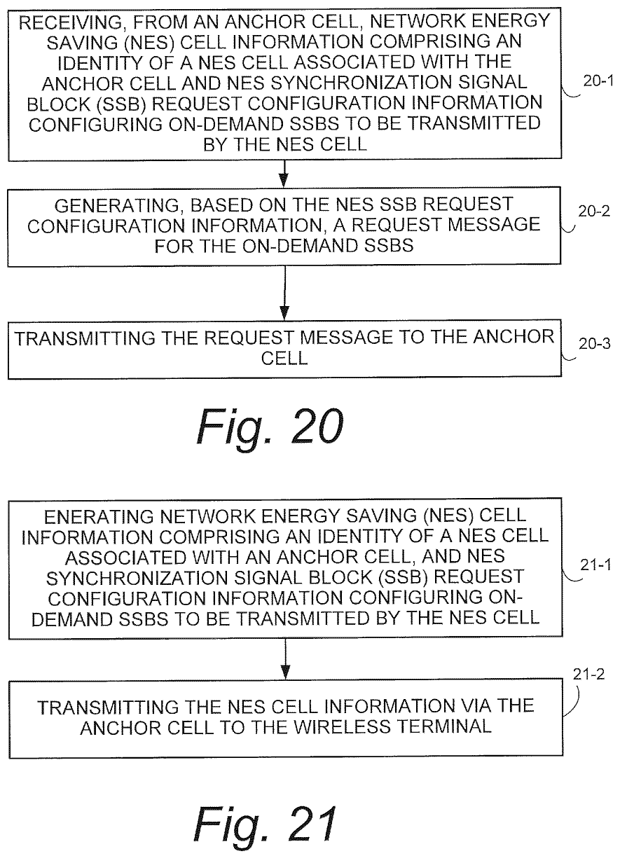

FIG. 20 is a flow chart showing example representative steps or acts performed by a wireless terminal of an example embodiment and mode of FIG. 16 and FIG. 17 and section 4.0. Act 20-1 comprises receiving, from an anchor cell, network energy saving (NES) cell information comprising an identity of a NES cell associated with the anchor cell and NES Synchronization Signal Block (SSB) request configuration information configuring on-demand SSBs to be transmitted by the NES cell. The NES SSB request configuration information may configure one or more Random Access Channel (RACH) preambles and one or more RACH resources designated for the request message.

Act 20-2 comprises generating, based on the NES SSB request configuration information, a request message for the on-demand SSBs. The request message comprises the identity of the NES cell.

Act 20-3 comprises transmitting the request message to the anchor cell. The wireless terminal may receive, based on the request message, from the NES cell, the on-demand SSBs.

FIG. 21 is a flow chart showing example representative steps or acts performed by an access node of an example embodiment and mode of FIG. 16 and FIG. 17 and section 4.0. Act 21-1 comprises generating network energy saving (NES) cell information comprising an identity of a NES cell associated with an anchor cell, and NES Synchronization Signal Block (SSB) request configuration information configuring on-demand SSBs to be transmitted by the NES cell. The NES SSB request configuration information may configure one or more Random Access Channel (RACH) preambles and one or more RACH resources designated for the request message. Act 21-2 comprises transmitting the NES cell information via the anchor cell to the wireless terminal. The NES cell information may be used by the wireless terminal to send, to the anchor cell, a request message for the on-demand SSBs. The request message may comprise the identity of the NES cell. The access node may receive, via the anchor cell, from the wireless terminal, the request message, which will cause the access node to instruct the NES cell to transmit the on-demand SSBs.

### 5.0:Cell Barring Handling for Network Energy Saving Cells

In the example embodiments and modes described in the foregoing sections 1.0, 2.0, 3.0 and 4.0 hereof, in basic operation a wireless terminal first discovers and camps on a serving cell and, if the serving cell is an anchor cell of associated NES cells, acquires essential information for accessing one or more NES cells from the anchor cell. Then the wireless terminal may proceed to cell reselection to reselect one of the associated NES cells. When camping on the serving cell, it should be assured that the serving cell is not a NES cell, since a NES cell cannot be camped without assistance from its anchor cell.

While it is unlikely or impossible to discover SIB/SSB-less NES cells due to lack of SSB, it is possible that the wireless terminal may discover a SIB-less NES cell and attempt to camp on the SIB-less NES cell. Eventually the wireless terminal may fail to acquire system information, e.g., SIB1, from the SIB-less NES cell. To avoid wasting the wireless terminal's resources, in the example embodiment and mode of FIG. 22 and section 5.0 SIB-less NES cells indicate their SIB-less status in broadcast signals, preferably in their Synchronization Signal Blocks, SSBs. Section 5.0 thus describes example embodiments and modes in which SIB-less NES cells indicate their SIB-less status in broadcast signals.

It is well known that, in the 3GPP 5G system, specific values of ssb-SubcarrierOffset of MIB in Listing 7 can indicate that a cell broadcasting the MIB does not provide SIB1. This may be originally designed for a non-standalone (NSA) cell in Dual Connectivity, DC, and the wireless terminal may treat this cell as if the cell is “barred”. In one configuration of the example embodiments and modes of FIG. 22 and section 5.0, this mechanism may be also used to indicate the status for SIB-less NES cells. In another configuration, another information in the MIB or in the SSB may be used to indicate the SIB-less status, e.g., using the “spare” of Listing 7.

Listing 7

| MIB ::= | SEQUENCE { |
|---|---|
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, |
| pos3}, | |
| pdcch-ConfigSIB1 | PDCCH-ConfigSIB1, |
| cellBarred | ENUMERATED {barred, |
| notBarred}, | |
| intraFreqReselection | ENUMERATED {allowed, |
| notAllowed}, | |
| spare | BIT STRING (SIZE (1)) |

}

In a case that the wireless terminal discovers a SIB-less NES cell, the wireless terminal may treat this cell as “barred” based on the MIB and look for other cells. At this moment, the wireless terminal may not know if the cell is a NES cell since the MIB just indicates unavailability of SIB1. For example, the cell could be a non-standalone (NSA) cell of DC.

The wireless terminal may then discover and camp on a non-barred cell. If the camped cell is an anchor cell, the system information from the anchor cell may provide NES cell information as disclosed in the previous embodiments and sections. After acquiring the NES cell information, the wireless terminal may know that the SIB-less cell previously discovered is a SIB-less and is an NES cell.

The wireless terminal of the example embodiments and modes of FIG. 22 and section 5.0 may treat this SIB-less NES cell as a “notBarred” cell, in a case that the wireless terminal reselects the SIB-less NES cell, ignoring the status indicated by MIB/SSB, e.g., ssb-SubcarrierOffset. This can be done only when the wireless terminal acquires, from the anchor cell, that the reselected cell is an NES cell.

### 5.1: Cell Barring Handling for Network Energy Saving Cells:Example Structure

FIG. 22 shows, in generic manner, a communications network or system suitable for implementation of the technology of section 5.0 wherein Synchronization Signal Block (SSB) information is provided on-demand for a NES cell. The architectural and structure of the nodes and units shown in FIG. 22 are identical to those in preceding example embodiments and modes such as FIG. 4, FIG. 7, FIG. 10, and FIG. 16, except as described herein or otherwise apparent. For example, except as otherwise described in section 5.0, the access node 26A and access node 26B of FIG. 22 have the same structure and operation as shown and described with reference to FIG. 4, FIG. 7, FIG. 10, and FIG. 16, and wireless terminal 30 has the same structure and operation as shown and described with reference to FIG. 4, FIG. 7, FIG. 10, and FIG. 16, regardless of whether the structural elements of such other example embodiments and modes are explicitly illustrated in FIG. 22, since some structural elements may not be again illustrated for sake of simplicity.

As in other sections hereof, in the example embodiment and mode of FIG. 22 and section 5.0 the wireless terminal 30 obtains network energy saving (NES) cell information from the access node 26A that serves the anchor cell 22A. For example, the NES cell information generator 42 of access node 26A provides the NES cell information as shown by message 56(22) of FIG. 22.

A first example difference between the structure of FIG. 22 and previously described example embodiments and modes includes the access node processors 34B of access node 26B which serves NES cell 22B as comprising NES Synchronization Signal Block (SSB) generator 120. In particular, the NES Synchronization Signal Block (SSB) generator 100 serves to generate, e.g., a Synchronization Signal Block (SSB) comprising an indication indicating that a first cell served by the access node does not provide system information, e.g., that NES cell 22B served by access node 26B node does not provide system information. The transmission of such Synchronization Signal Block (SSB), which includes the indication that the cell 22B served by the access node 26B does not provide system information, is represented by SSB message arrow 122 in FIG. 22.

second example difference between the structure of FIG. 22 and the previous example embodiments and modes of FIG. 4, FIG. 7, FIG. 10, and FIG. 16 includes the wireless terminal processor(s) 60 of wireless terminal 30 as comprising terminal SSB analyzer 124 and cell selection/re-selection controller 126, shown as cell (re)-selector 126 in FIG. 22. One or both of terminal SSB analyzer 124 and cell (re)-selector 126 may comprise or work in conjunction with idle/active mode procedure controller 68, and thus may comprise or be included in wireless terminal processor(s) 60. The terminal SSB analyzer 124 receives the Synchronization Signal Block (SSB) represented by SSB message arrow 122 in FIG. 22 and obtains the indication that the cell 22B served by the access node 26B does not provide system information from the Synchronization Signal Block (SSB). The cell (re)-selector 126 then performs a cell selection/reselection procedure to determine, based on the SSB, and thus determines whether or not to select/reselect the cell 22B. the cell (re)-selector 126 is configured so that, in a case that the wireless terminal has received, from an anchor cell, network energy saving (NES) cell information indicating that the cell 22B is an NES cell associated with the anchor cell, the cell 22b is treated as a candidate for the cell selection/reselection procedure.

Thus, in the example embodiment and mode of FIG. 22 and section 5.0, wireless terminal 30 comprises receiver circuitry 54 and processor circuitry 60. The receiver circuitry 54 is configured to receive, from a first cell, a Synchronization Signal Block (SSB) comprising an indication indicating that the first cell does not provide system information. The processor circuitry 60, which may include cell (re)-selector 126, is configured to perform a cell selection/reselection procedure to determine, based on the SSB, whether or not to select/reselect the cell. In a case that the wireless terminal has received, from an anchor cell, network energy saving (NES) cell information indicating that the first cell is an NES cell associated with the anchor cell, the first cell is treated as a candidate for the cell selection/reselection procedure.

The example embodiment and mode of FIG. 22 and section 5.0 also concerns an access node of a cellular telecommunication system, such as, for example access node 26B of NES cell 22B. The access node comprises processor circuitry and transmitter circuitry, such as access node processors 34B and transmitter circuitry 37B. The processor circuitry, which may include NES Synchronization Signal Block (SSB) generator 100, is configured to generate a Synchronization Signal Block (SSB) comprising an indication indicating that a first cell served by the access node does not provide system information. The transmitter circuitry is configured to transmit, via the first cell, to a wireless terminal, the SSB. The indication is configured to be used by the wireless terminal to perform a cell selection/reselection procedure to determine whether or not to select/reselect the cell. In a case that the wireless terminal has received, from an anchor cell, network energy saving (NES) cell information indicating that the first cell is an NES cell associated with the anchor cell, the first cell is treated as a candidate for the cell selection/reselection procedure.

### 5.2: Cell Barring Handling for Network Energy Saving Cells:Example Operation

FIG. 23 is a flow chart for an example operation of cell selection/reselection for the wireless terminal of the example embodiment and mode of FIG. 22 and section 5.0. After starting at act 23-0, as act 23-1 the wireless terminal may scan radio frequencies and discover a cell. By “discovering a cell” means that the wireless terminal receives the Synchronization Signal Block (SSB) of this discovered cell, as shown by arrow 122 in FIG. 22. From the received SSB, as act 23-2 the wireless terminal may check, using the MIB in the SSB, if the discovered cell is SIB-less. The terminal SSB analyzer 124 of wireless terminal 30 may perform the check of act 23-2. If the discovered cell is not SIB-less, as act 16-3 the discovered cell may be a non-NES cell and thus may be treated as a candidate. On the other hand, if the discovered cell is SIB-less, as act 23-4 the wireless terminal may further check if the NES cell information has been already received for the discovered cell from an associated anchor cell. If the check of act 23-4 is affirmative, as act 23-3 the discovered cell may be treated as a candidate for cell selection/reselection in a cell selection/reselection process performed, e.g., by cell (re)-selector 126, despite the SIB-less status indicated by the MIB/SSB. Otherwise, as act 23-5, the discovered cell may be treated as, therefore not considered as a candidate for cell selection/reselection.

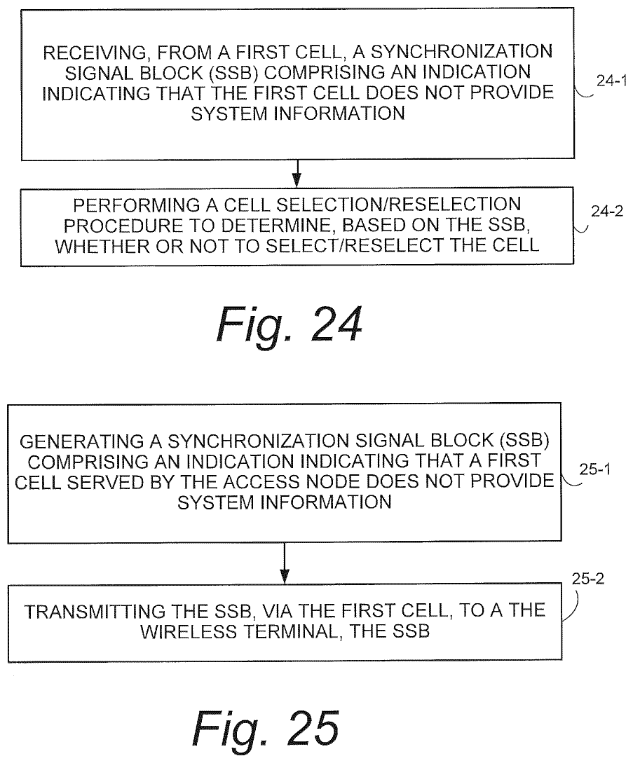

FIG. 24 is a flow chart showing example representative steps or acts performed by a wireless terminal of an example embodiment and mode of FIG. 22 and FIG. 23 and section 5.0 hereof.

Act 24-1 comprises receiving, from a first cell, a Synchronization Signal Block (SSB) comprising an indication indicating that the first cell does not provide system information. FIG. 22 shows by arrow 122 the transmission of the SSB block. The indication may be included in master system information (MIB). The system information may comprise system information block type 1 (SIB1).

Act 24-2 comprises performing a cell selection/reselection procedure to determine, based on the SSB, whether or not to select/reselect the cell. Act 24-2 may be performed by cell (re)-selector 126. In a case that the wireless terminal has received, from an anchor cell, network energy saving (NES) cell information indicating that the first cell is an NES cell associated with the anchor cell, the first cell may be treated as a candidate for the cell selection/reselection procedure. Otherwise, the first cell may be treated as barred and/or may not treat the first cell as a candidate for the cell selection/reselection procedure. The NES cell information from the anchor cell may further indicate that the first cell does not provide system information.

FIG. 25 is a flow chart showing example representative steps or acts performed by an access node of an example embodiment and mode of FIG. 22 and FIG. 23 and section 5.0 hereof. Act 25-1 comprises generating a Synchronization Signal Block (SSB) comprising an indication indicating that a first cell served by the access node does not provide system information. The SSB may be generated by NES Synchronization Signal Block (SSB) generator 100. The indication may be included in master system information (MIB). The system information may comprise system information block type 1 (SIB1).

Act 25-2 comprises transmitting the SSB via the first cell to the wireless terminal. Transmission of the SSB is depicted in example manner by arrow 122 of FIG. 22. The indication may be used by the wireless terminal to perform a cell selection/reselection procedure to determine whether or not to select/reselect the cell. In a case that the wireless terminal has received, from an anchor cell, network energy saving (NES) cell information indicating that the first cell is an NES cell associated with the anchor cell, the first cell may be treated as a candidate for the cell selection/reselection procedure. Otherwise, the first cell may be treated as barred and/or may not treat the first cell as a candidate for the cell selection/reselection procedure. The NES cell information from the anchor cell may further indicate that the first cell does not provide system information.

### 6.0 Further Considerations

Thus, in some of its example aspects the technology disclosed herein involves structure and operation of base wireless terminals and base station nodes operating in conjunction therewith, including but not limited to the following.
An anchor cell provides network energy saving (NES) cell information, preferably as a part of system information. The NES cell information comprises identities of NES cells associated with the anchor cell. A wireless terminal may use the NES cell information for derivation of synchronization information.
The NES cell information further provides essential information for each of the NES cells, to be used by the wireless terminal when accessing one of the NES cells.
The NES cell information further configures on-demand system information for the NES cells. The wireless terminal sends a request message to the anchor cell and receives the requested system information from one of the NES cells.
The NES cell information further configures on-demand Synchronization Signal Block (SSB) transmission for the NES cells. The wireless terminal sends a request message to the anchor cell and receives the requested SSBs from one of the NES cells.
The wireless terminal ignores SIB-less/barred status indicated in the SSB of a discovered cell, if the wireless terminal has already received, from an anchor cell, the NES cell information indicating the discovered cell is a NES cell associated with the anchor cell.

It should be understood that the various foregoing example embodiments and modes may be utilized in conjunction with one or more other example embodiments and modes described herein.

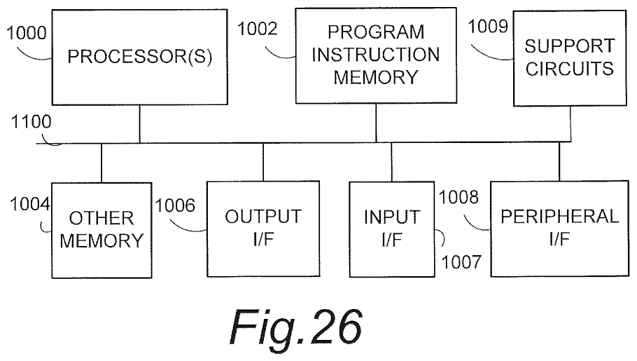

Certain units and functionalities of the systems 20 may be implemented by electronic machinery. For example, electronic machinery may refer to the processor circuitry described herein, such as terminal processor circuitry 60 and node processor(s) 34. Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 26 shows an example of electronic machinery, e.g., processor circuitry, as comprising one or more processors 1000, program instruction memory 1002; other memory 1004 (e.g., RAM, cache, etc.); input/output interfaces 1006 and 1007, peripheral interfaces 1008; support circuits 1009; and busses 1010 for communication between the aforementioned units. The processor(s) 1000 may comprise the processor circuitries described herein, for example, terminal processor circuitry 60 and access node processors 34, or any processor(s) of a network entity of the core network.

A memory or register described herein may be depicted by memory 1004, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 1009 are coupled to the processors 1000 for supporting the processor in a conventional manner. These circuits include cache, power supplies, clock circuits, input/output circuitry and subsystems, and the like.

The term “configured” may relate to the capacity of a device whether the device is in an operational or non-operational state. Configured may also refer to specific settings in a device that effect the operational characteristics of the device whether the device is in an operational or nonoperational state. In other words, the hardware, software, firmware, registers, memory values, and/or the like may be “configured” within a device, whether the device is in an operational or nonoperational state, to provide the device with specific characteristics.

An interface may be a hardware interface, a firmware Interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The technology of the example embodiments and modes described herein encompasses a non-transitory computer readable medium encoded with a computer program that, when executed by a computer or processor of the wireless terminal described herein, causes the computer to implement the acts described herein, and/or a non-transitory computer readable medium encoded with a computer program that, when executed by a computer or processor of the mobile base station relay described herein, causes the computer to implement the acts described herein.

Moreover, each functional block or various features of the wireless terminals and nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein cell energy savings in a communications system.

The technology disclosed herein encompasses one or more of the following non-limiting, non-exclusive example embodiments and modes:

Example Embodiment 1.1:A wireless terminal of a cellular telecommunication system, the wireless terminal comprising:
receiver circuitry configured to receive, from an anchor cell, network energy saving (NES) cell information comprising an identity of a NES cell associated with the anchor cell, the NES cell being a cell that refrains from periodically transmitting broadcast signals for energy saving; and,
processor circuitry configured to perform, based on the NES cell information, an idle/inactive mode procedure.

Example Embodiment 1.2: The wireless terminal of Example Embodiment 1.1, wherein the NES cell information further comprises information indicating whether or not the NES cell broadcasts a Synchronization Signal Block (SSB).

Example Embodiment 1.3: The wireless terminal of Example Embodiment 1.1, wherein the NES cell information further comprises information indicating whether or not the NES cell broadcasts system information.

Example Embodiment 1.4: The wireless terminal of Example Embodiment 1.2, wherein the idle/inactive procedure is to derive synchronization information of the NES cell.

Example Embodiment 1.5: The wireless terminal of Example Embodiment 1.4, wherein the anchor cell's SSB is used to derive the synchronization information of the NES cell.

Example Embodiment 1.6: The wireless terminal of Example Embodiment 1.5, wherein the NES cell information further comprises an indication indicating whether or not the anchor cell's SSB can be used to derive the synchronization information of the NES cell.

Example Embodiment 1.7: An access node of a cellular telecommunication system, the access node comprising:
processor circuitry configured to generate network energy saving (NES) cell information, the NES cell information being configured for use by a wireless terminal to perform an idle/inactive mode procedure and comprising an identity of a NES cell which refrains from periodically transmitting broadcast signals for energy saving; and,
transmitter circuitry configured to transmit the NES cell information via an anchor cell to the wireless terminal.

Example Embodiment 1.8: The access node of Example Embodiment 1.7, wherein the NES cell information further comprises information indicating whether or not the NES cell broadcasts Synchronization Signal Block (SSB).

Example Embodiment 1.9: The access node of Example Embodiment 1.7, wherein the NES cell information further comprises information indicating whether or not the NES cell broadcasts system information.

Example Embodiment 1.10: The access node of Example Embodiment 1.8, wherein the idle/inactive procedure is to derive synchronization information of the NES cell.

Example Embodiment 1.11: The access node of Example Embodiment 1.10, wherein the anchor cell's SSB is used to derive the synchronization information of the NES cell.

Example Embodiment 1.12: The access node of Example Embodiment 1.11, wherein the NES cell information further comprises an indication indicating whether or not the anchor cell's SSB can be used to derive the synchronization information of the NES cell.

Example Embodiment 1.13: A method for a wireless terminal of a cellular telecommunication system, the method comprising:
receiving, from an anchor cell, network energy saving (NES) cell information comprising an identity of a NES cell associated with the anchor cell, the NES cell being a cell that refrains from periodically transmitting broadcast signals for energy saving; and,
performing an idle/inactive mode procedure based on the NES cell information.

Example Embodiment 1.14: The method of Example Embodiment 1.13, wherein the NES cell information further comprises information indicating whether or not the NES cell broadcasts Synchronization Signal Block (SSB).

Example Embodiment 1.15: The method of Example Embodiment 1.13, wherein the NES cell information further comprises information indicating whether or not the NES cell broadcasts system information.

Example Embodiment 1.16: The method of Example Embodiment 1.14, wherein the idle/inactive procedure is to derive synchronization information of the NES cell.

Example Embodiment 1.17: The method of Example Embodiment 1.16, wherein the anchor cell's SSB is used to derive the synchronization information of the NES cell.

Example Embodiment 1.18: The method of Example Embodiment 1.17, wherein the NES cell information further comprises an indication indicating whether or not the anchor cell's SSB can be used to derive the synchronization information of the NES cell.

Example Embodiment 1.19: A method for an access node of a cellular telecommunication system, the method comprising:
generating network energy saving (NES) cell information, the NES cell information being configured for use by a wireless terminal to perform an idle/inactive mode procedure and comprising an identity of a NES cell which refrains from periodically
transmitting broadcast signals for energy saving; and, transmitting the NES cell information via an anchor cell to the wireless terminal.

Example Embodiment 1.20: The method of Example Embodiment 1.19, wherein the NES cell information further comprises information indicating whether or not the NES cell broadcasts Synchronization Signal Block (SSB).

Example Embodiment 1.21: The method of Example Embodiment 1.19, wherein the NES cell information further comprises information indicating whether or not the NES cell broadcasts system information.

Example Embodiment 1.22: The method of Example Embodiment 1.20, wherein the idle/inactive procedure is to derive synchronization information of the NES cell.

Example Embodiment 1.23: The method of Example Embodiment 1.22, wherein the anchor cell's SSB is used to derive the synchronization information of the NES cell.

Example Embodiment 1.24: The method of Example Embodiment 1.23, wherein the NES cell information further comprises an indication indicating whether or not the anchor cell's SSB can be used to derive the synchronization information of the NES cell.

Example Embodiment 2.1: A wireless terminal of a cellular telecommunication system, the wireless terminal comprising:
receiver circuitry configured to receive, from an anchor cell, network energy saving (NES) cell information comprising:
an identity of a NES cell associated with the anchor cell; and,
essential information, the essential information comprising information required to access to the NES cell; and,
processor circuitry configured to access the NES cell using the NES information.

Example Embodiment 2.2: The wireless terminal of Example Embodiment 2.1, wherein the essential information comprises synchronization information of the NES cell.

Example Embodiment 2.3: The wireless terminal of Example Embodiment 2.1, wherein the essential information of the NES cell includes all or a subset of Master System Information (MIB).

Example Embodiment 2.4: The wireless terminal of Example Embodiment 2.1, wherein the essential information includes all or a subset of System Information Block Type 1 (SIB1).

Example Embodiment 2.5: The wireless terminal of Example Embodiment 2.1, wherein the essential information comprises all or a subset of Other SIBs.

Example Embodiment 2.6: An access node of a cellular telecommunication system, the access node comprising:
processor circuitry configured to generate network energy saving (NES) cell information comprising:
an identity of a NES cell associated with an anchor cell; and,
essential information, the essential information comprising information required to access to the NES cell; and,
transmitter circuitry configured to transmit the NES cell information via an anchor cell to a wireless terminal.

Example Embodiment 2.7: The access node of Example Embodiment 2.6, wherein the essential information comprises synchronization information of the NES cell.

Example Embodiment 2.8: The access node of Example Embodiment 2.6, wherein the essential information includes all or a subset of Master System Information (MIB).

Example Embodiment 2.9: The access node of Example Embodiment 2.6, wherein the essential information includes all or a subset of System Information Block Type 1 (SIB1).

Example Embodiment 2.10: The access node of Example Embodiment 2.6, wherein the essential information comprises all or a subset of Other SIBs.

Example Embodiment 2.11: A method for a wireless terminal of a cellular telecommunication system, the method comprising:
receiving, from an anchor cell, network energy saving (NES) cell information comprising:
an identity of a NES cell associated with the anchor cell; and,
essential information, the essential information comprising information required to access to the NES cell; and,
accessing the NES cell using the NES information.

Example Embodiment 2.12: The method of Example Embodiment 2.11, wherein the essential information comprises synchronization information of the NES cell.

Example Embodiment 2.13: The method of Example Embodiment 2.11, wherein the essential information includes all or a subset of Master System Information (MIB).

Example Embodiment 2.14: The method of Example Embodiment 2.11, wherein the essential information includes all or a subset of System Information Block Type 1 (SIB1).

Example Embodiment 2.15: The method of Example Embodiment 2.11, wherein the essential information comprises all or a subset of Other SIBs.

Example Embodiment 2.16: A method for an access node of a cellular telecommunication system, the method comprising:
generating network energy saving (NES) cell information comprising:
an identity of a NES cells associated with an anchor cell; and,
essential information, the essential information comprising information required to access to the NES cell; and,
transmitting the NES cell information via an anchor cell to a wireless terminal.

Example Embodiment 2.17: The method of Example Embodiment 2.16, wherein the essential information comprises synchronization information of the NES cells.

Example Embodiment 2.18: The method of Example Embodiment 2.16, wherein the essential information includes all or a subset of Master System Information (MIB).

Example Embodiment 2.19: The method of Example Embodiment 2.16, wherein the essential information includes all or a subset of System Information Block Type 1 (SIB1).

Example Embodiment 2.20: The method of Example Embodiment 2.16, wherein the essential information comprises all or a subset of Other SIBs.

Example Embodiment 3.1: A wireless terminal of a cellular telecommunication system, the wireless terminal comprising:
receiver circuitry configured to receive, from an anchor cell, network energy saving (NES) cell information comprising:
an identity of a NES cell associated with the anchor cell; and,
NES system information (SI) request configuration information configuring on-demand system information to be broadcasted by the NES cell;
processor circuitry configured to generate, based on the NES SI request configuration information, a request message for the on-demand system information, and; transmitter circuitry configured to transmit the request message to the anchor cell.

Example Embodiment 3.2: The wireless terminal of Example Embodiment 3.1, wherein the NES SI request configuration information configures one or more Random Access Channel (RACH) preambles and one or more RACH resources designated for the request message.

Example Embodiment 3.3: The wireless terminal of Example Embodiment 3.1, wherein the request message comprises the identity of the NES cell.

Example Embodiment 3.4: The wireless terminal of Example Embodiment 3.1, wherein the receiver circuitry is further configured to receive, based on the request message, from the NES cell, the on-demand system information.

Example Embodiment 3.5: The wireless terminal of Example Embodiment 3.1, wherein the on-demand system information includes System Information Block Type 1 (SIB1).

Example Embodiment 3.6: An access node of a cellular telecommunication system, the access node comprising:
processor circuitry configured to generate network energy saving (NES) cell information comprising:
an identity of a NES cell associated with an anchor cell; and,
NES system information (SI) request configuration information configuring on-demand system information to be broadcasted by the NES cell, the NES cell information being configured for use by a wireless terminal to send, to the anchor cell, a request message for the on-demand system information; and,
transmitter circuitry configured to transmit the NES cell information via the anchor cell to the wireless terminal.

Example Embodiment 3.7: The access node of Example Embodiment 3.6, wherein the NES SI request configuration information configures one or more Random Access Channel (RACH) preambles and one or more RACH resources designated for the request message.

Example Embodiment 3.8: The access node of Example Embodiment 3.6, wherein the request message comprises the identity of the NES cell.

Example Embodiment 3.9: The access node of Example Embodiment 3.6, wherein the receiver circuitry is further configured to receive, via the anchor cell, from the wireless terminal, the request message.

Example Embodiment 3.10: The access node of Example Embodiment 3.9, wherein based on the request message the processor circuitry is further configured to instruct the NES cell to transmit the on-demand system information.

Example Embodiment 3.11: The access node of Example Embodiment 3.6, wherein the on-demand system information includes System Information Block Type 1 (SIB1).

Example Embodiment 3.12: A method for a wireless terminal of a cellular telecommunication system, the method comprising:
receiving, from an anchor cell, network energy saving (NES) cell information comprising:
an identity of a NES cell associated with the anchor cell; and,
NES system information (SI) request configuration information configuring on-demand system information to be broadcasted by the NES cell;
generating, based on the NES SI request configuration information, a request message for the on-demand system information; and,
transmitting the request message to the anchor cell. Example Embodiment 3.13: The method of Example Embodiment 3.12, wherein the NES SI request configuration information configures one or more Random Access Channel (RACH) preambles and one or more RACH resources designated for the request message.

Example Embodiment 3.14: The method of Example Embodiment 3.12, wherein the request message comprises the identity of the NES cell.

Example Embodiment 3.15: The method of Example Embodiment 3.12, further comprising receiving, based on the request message, from the NES cell, the on-demand system information.

Example Embodiment 3.16: The method of Example Embodiment 3.12, wherein the on-demand system information includes System Information Block Type 1 (SIB1).

Example Embodiment 3.17: A method for an access node of a cellular telecommunication system, the method comprising:
generating network energy saving (NES) cell information comprising:
an identity of a NES cell associated with an anchor cell; and,
NES system information (SI) request configuration information configuring on-demand system information to be broadcasted by the NES cell, the NES cell information being configured for use by the wireless terminal to send, to the anchor cell, a request message for the on-demand system information; and,
transmitting the NES cell information via the anchor cell to the wireless terminal.

Example Embodiment 3.18: The method of Example Embodiment 3.17, wherein the NES SI request configuration information configures one or more Random Access Channel (RACH) preambles and one or more RACH resources designated for the request message.

Example Embodiment 3.19: The method of Example Embodiment 3.17, wherein the request message comprises the identity of the NES cell.

Example Embodiment 3.20: The method of Example Embodiment 3.17, further comprising receiving, via the anchor cell, from the wireless terminal, the request message.

Example Embodiment 3.21: The method of Example Embodiment 3.20, wherein based on the request message the processor circuitry is further configured to instruct the NES cell to transmit the on-demand system information.

Example Embodiment 3.22: The method of Example Embodiment 3.17, wherein the on-demand system information includes System Information Block Type 1 (SIB1).

Example Embodiment 4.1: A wireless terminal of a cellular telecommunication system, the wireless terminal comprising:
receiver circuitry configured to receive, from an anchor cell, network energy saving (NES) cell information comprising:
an identity of a NES cell associated with the anchor cell; and,
NES Synchronization Signal Block (SSB) request configuration information configuring on-demand SSBs to be transmitted by the NES cell;
processor circuitry configured to generate, based on the NES SSB request configuration information, a request message for the on-demand SSBs; and,
transmitter circuitry configured to transmit the request message to the anchor cell.

Example Embodiment 4.2: The wireless terminal of Example Embodiment 4.1, wherein the NES SSB request configuration information configures one or more Random Access Channel (RACH) preambles and one or more RACH resources designated for the request message.

Example Embodiment 4.3: The wireless terminal of Example Embodiment 4.1, wherein the request message comprises the identity of the NES cell.

Example Embodiment 4.4: The wireless terminal of Example Embodiment 4.1, wherein the receiver circuitry is further configured to receive, based on the request message, from the NES cell, the on-demand SSBs.

Example Embodiment 4.5: An access node of a cellular telecommunication system, the access node comprising:
processor circuitry configured to generate network energy saving (NES) cell information comprising:
an identity of a NES cell associated with an anchor cell; and,
NES Synchronization Signal Block (SSB) request configuration information configuring on-demand SSBs to be transmitted by the NES cell, the NES cell information being configured for used by a wireless terminal to send a request message for the on-demand SSBs to the anchor cell; and,
transmitter circuitry configured to transmit the NES cell information via the anchor cell to the wireless terminal.

Example Embodiment 4.6: The access node of Example Embodiment 4.5, wherein the NES SSB request configuration information configures one or more Random Access Channel (RACH) preambles and one or more RACH resources designated for the request message.

Example Embodiment 4.7: The access node of Example Embodiment 4.5, wherein the request message comprises the identity of the NES cell.

Example Embodiment 4.8: The access node of Example Embodiment 4.5, wherein the access node further comprises receiver circuitry configured to receive, via the anchor cell, from the wireless terminal, the request message.

Example Embodiment 4.9: The access node of Example Embodiment 4.8, wherein based on the request message the processor circuitry is further configured to instruct the NES cell to transmit the on-demand SSBs.

Example Embodiment 4.10: A method for a wireless terminal of a cellular telecommunication system, the method comprising:
receiving, from an anchor cell, network energy saving (NES) cell information comprising:
an identity of a NES cell associated with the anchor cell; and,
NES Synchronization Signal Block (SSB) request configuration information configuring on-demand SSBs to be transmitted by the NES cell;
generating, based on the NES SSB request configuration information, a request message for the on-demand SSBs; and,
transmitting the request message to the anchor cell.

Example Embodiment 4.11: The method of Example Embodiment 4.10,wherein the NES SSB request configuration information configures one or more Random Access Channel (RACH) preambles and one or more RACH resources designated for the request message.

Example Embodiment 4.12: The method of Example Embodiment 4.10, wherein the request message comprises the identity of the NES cell.

Example Embodiment 4.13: The method of Example Embodiment 4.10, wherein the receiver circuitry is further configured to receive, based on the request message, from the NES cell, the on-demand SSBs.

Example Embodiment 4.14: A method for an access node of a cellular telecommunication system, the method comprising:
generating network energy saving (NES) cell information comprising:
an identity of a NES cell associated with an anchor cell; and,
NES Synchronization Signal Block (SSB) request configuration information configuring on-demand SSBs to be transmitted by the NES cell, the NES cell information being configured for used by a wireless terminal to send a request message for the on-demand SSBs to the anchor cell;
transmitter circuitry configured to transmit the NES cell information via the anchor cell to the wireless terminal.

Example Embodiment 4.15: The method of Example Embodiment 4.14, wherein the NES SSB request configuration information configures one or more Random Access Channel (RACH) preambles and one or more RACH resources designated for the request message.

Example Embodiment 4.16: The method of Example Embodiment 4.14, wherein the request message comprises the identity of the NES cell.

Example Embodiment 4.17: The method of Example Embodiment 4.14, further comprising receiving, via the anchor cell, from the wireless terminal, the request message.

Example Embodiment 4.18: The method of Example Embodiment 4.17, further comprising instructing, based on the request message, the NES cell to transmit the on-demand SSBs.

Example Embodiment 5.1: A wireless terminal of a cellular telecommunication system, the wireless terminal comprising:
receiver circuitry configured to receive, from a first cell, a Synchronization Signal Block (SSB) comprising an indication indicating that the first cell does not provide system information; and,
processor circuitry configured to perform a cell selection/reselection procedure to determine, based on the SSB, whether or not to select/reselect the cell; and,
wherein in a case that the wireless terminal has received, from an anchor cell, network energy saving (NES) cell information indicating that the first cell is an NES cell associated with the anchor cell, the first cell is treated as a candidate for the cell selection/reselection procedure.

Example Embodiment 5.2: The wireless terminal of Example Embodiment 5.1, wherein in a case that the wireless terminal has not received network energy saving (NES) cell information indicating that the first cell is an NES cell, the first cell is treated as barred for the cell selection/reselection procedure.

Example Embodiment 5.3: The wireless terminal of Example Embodiment 5.1, wherein the indication is included in master system information (MIB).

Example Embodiment 5.4: The wireless terminal of Example Embodiment 5.1, wherein the NES cell information further indicates that the first cell does not provide system information.

Example Embodiment 5.5: The wireless terminal of Example Embodiment 5.1, wherein the system information comprises system information block type 1 (SIB1).

Example Embodiment 5.6: An access node of a cellular telecommunication system, the access node comprising:
processor circuitry configured to generate a Synchronization Signal Block (SSB) comprising an indication indicating that a first cell served by the access node does not provide system information; and,
transmitter circuitry configured to transmit, via the first cell, to a wireless terminal, the SSB, wherein;
wherein the indication is configured to be used by the wireless terminal to perform a cell selection/reselection procedure to determine whether or not to select/reselect the cell, and wherein in a case that the wireless terminal has received, from an anchor cell, network energy saving (NES) cell information indicating that the first cell is an NES cell associated with the anchor cell, the first cell is treated as a candidate for the cell selection/reselection procedure.

Example Embodiment 5.7: The access node of Example Embodiment 5.6, wherein in a case that the wireless terminal has not received network energy saving (NES) cell information indicating that the first cell is an NES cell, the first cell is treated as barred for the cell selection/reselection procedure.

Example Embodiment 5.8: The access node of Example Embodiment 5.6, wherein the indication is included in master system information (MIB).

Example Embodiment 5.9: The access node of Example Embodiment 5.6, wherein the NES cell information further indicates that the first cell does not provide system information.

Example Embodiment 5.10: The access node of Example Embodiment 5.6, wherein the system information comprises system information block type 1 (SIB1).

Example Embodiment 5.11: A method for a wireless terminal of a cellular telecommunication system, the method comprising:
receiving, from a first cell, a Synchronization Signal Block (SSB) comprising an indication indicating that the first cell does not provide system information; and,
performing a cell selection/reselection procedure to determine, based on the SSB, whether or not to select/reselect the cell; and,
wherein in a case that the wireless terminal has received, from an anchor cell, network energy saving (NES) cell information indicating that the first cell is an NES cell associated with the anchor cell, the first cell is treated as a candidate for the cell selection/reselection procedure.

Example Embodiment 5.12: The method of Example Embodiment 5.11, wherein in a case that the wireless terminal has not received network energy saving (NES) cell information indicating that the first cell is an NES cell, the first cell is treated as barred for the cell selection/reselection procedure.

Example Embodiment 5.13: The method of Example Embodiment 5.11, wherein the indication is included in master system information (MIB).

Example Embodiment 5.14: The method of Example Embodiment 5.11, wherein the NES cell information further indicates that the first cell does not provide system information.

Example Embodiment 5.15: The method of Example Embodiment 5.11, wherein the system information comprises system information block type 1 (SIB1).

Example Embodiment 5.16: A method for an access node of a cellular telecommunication system, the method comprising:
generating a Synchronization Signal Block (SSB) comprising an indication indicating that a first cell served by the access node does not provide system information; and.
transmitting, via the first cell, to a wireless terminal, the SSB; and,
wherein the indication is configured to be used by the wireless terminal to perform a cell selection/reselection procedure to determine whether or not to select/reselect the cell, and wherein in a case that the wireless terminal has received, from an anchor cell, network energy saving (NES) cell information indicating that the first cell is an NES cell associated with the anchor cell, the first cell is treated as a candidate for the cell selection/reselection procedure.

Example Embodiment 5.17: The method of Example Embodiment 5.16, wherein in a case that the wireless terminal has not received network energy saving (NES) cell information indicating that the first cell is an NES cell, the first cell is treated as barred for the cell selection/reselection procedure.

Example Embodiment 5.18: The method of Example Embodiment 5.16, wherein the indication is included in master system information (MIB).

Example Embodiment 5.19: The method of Example Embodiment 5.16, wherein the NES cell information further indicates that the first cell does not provide system information.

Example Embodiment 5.20: The method of Example Embodiment 5.16, wherein the system information comprises system information block type 1 (SIB1).

Therefore, the technology disclosed herein provides, in its various example embodiments and modes, network energy consumption models, especially for a base station, that identifies and provides network energy savings techniques in targeted deployment scenarios. The technology disclosed herein achieves more efficient operation dynamically and/or semi-statically and finer granularity adaptation of transmissions and/or receptions in one or more of network energy saving techniques in time, frequency, spatial, and power domains. The technology disclosed herein may be combined with potential support/feedback from a wireless terminal, UE, potential UE assistance information, and information exchange/coordination over network interfaces.

The example embodiment and mode of section 1.0, section 2.0, section 3.0, section 4.0, and section 5.0 as described herein above may be combined, either completely or in part, with example embodiments and modes of any other such sections. For example, structural elements of any of FIG. 4, FIG. 7, FIG. 10, FIG. 16, and FIG. 22 may be combined and utilized in addition to or in conjunction with each other.

One or more of the following documents may be pertinent to the technology disclosed herein (all of which are incorporated herein by reference in their entirety):
3GPP TR 38.864 v1.0.0
3GPP TS 38.304 v17.3.0
3GPP R2-2213266 TP on SSB/SIBless Ericsson

Although the description above contains many specificities, these should not be construed as limiting the scope of the technology disclosed herein but as merely providing illustrations of some of the presently preferred embodiments of the technology disclosed herein. Thus, the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

In one example, a wireless terminal of a cellular telecommunication system comprising: receiver circuitry configured to receive, from an anchor cell, network energy saving (NES) cell information comprising an identity of a NES cell associated with the anchor cell, the NES cell being a cell that refrains from periodically transmitting broadcast signals for energy saving; and, processor circuitry configured to perform, based on the NES cell information, an idle/inactive mode procedure.

In one example, the wireless terminal, wherein the NES cell information further comprises information indicating whether or not the NES cell broadcasts a Synchronization Signal Block (SSB).

In one example, the wireless terminal, wherein the NES cell information further comprises information indicating whether or not the NES cell broadcasts system information.

In one example, the wireless terminal, wherein the idle/inactive procedure is to derive synchronization information of the NES cell.

In one example, the wireless terminal, wherein the anchor cell's SSB is used to derive the synchronization information of the NES cell.

In one example, the wireless terminal, wherein the NES cell information further comprises an indication indicating whether or not the anchor cell's SSB can be used to derive the synchronization information of the NES cell.

In one example, an access node of a cellular telecommunication system, wherein the access node comprising: processor circuitry configured to generate network energy saving (NES) cell information, the NES cell information being configured for use by a wireless terminal to perform an idle/inactive mode procedure and comprising an identity of a NES cell which refrains from periodically transmitting broadcast signals for energy saving; and, transmitter circuitry configured to transmit the NES cell information via an anchor cell to the wireless terminal.

In one example, the access node, wherein the NES cell information further comprises information indicating whether or not the NES cell broadcasts Synchronization Signal Block (SSB).

In one example, the access node, wherein the NES cell information further comprises information indicating whether or not the NES cell broadcasts system information.

In one example, the access node, wherein the idle/inactive procedure is to derive synchronization information of the NES cell.

In one example, the access node, wherein the anchor cell's SSB is used to derive the synchronization information of the NES cell.

In one example, the access node, wherein the NES cell information further comprises an indication indicating whether or not the anchor cell's SSB can be used to derive the synchronization information of the NES cell.

In one example, a method for a wireless terminal of a cellular telecommunication system, the method comprising: receiving, from an anchor cell, network energy saving (NES) cell information comprising an identity of a NES cell associated with the anchor cell, the NES cell being a cell that refrains from periodically transmitting broadcast signals for energy saving; and, performing an idle/inactive mode procedure based on the NES cell information.

In one example, the method, wherein, the NES cell information further comprises information indicating whether or not the NES cell broadcasts Synchronization Signal Block (SSB).

In one example, the method, wherein the NES cell information further comprises information indicating whether or not the NES cell broadcasts system information.

In one example, the method, wherein the idle/inactive procedure is to derive synchronization information of the NES cell.

In one example, the method, wherein the anchor cell's SSB is used to derive the synchronization information of the NES cell.

In one example, the method, wherein the NES cell information further comprises an indication indicating whether or not the anchor cell's SSB can be used to derive the synchronization information of the NES cell.

In one example, a method for an access node of a cellular telecommunication system, the method comprising: generating network energy saving (NES) cell information, the NES cell information being configured for use by a wireless terminal to perform an idle/inactive mode procedure and comprising an identity of a NES cell which refrains from periodically transmitting broadcast signals for energy saving; and, transmitting the NES cell information via an anchor cell to the wireless terminal.

In one example, the method, wherein the NES cell information further comprises information indicating whether or not the NES cell broadcasts Synchronization Signal Block (SSB).

In one example, the method, wherein the NES cell information further comprises information indicating whether or not the NES cell broadcasts system information.

In one example, the method, wherein the idle/inactive procedure is to derive synchronization information of the NES cell.

In one example, the method, wherein the anchor cell's SSB is used to derive the synchronization information of the NES cell.

In one example, the method, wherein the NES cell information further includes an indication indicating whether or not the anchor cell's SSB can be used to derive the synchronization information of the NES cell.

### CROSS REFERENCE

This Nonprovisional application claims priority under 35 U.S.C. § 119 on provisional Application No. 63/484,911 on Feb. 14, 2023, the entire contents of which are hereby incorporated by reference.

1. A wireless terminal of a cellular telecommunication system, the wireless terminal comprising:
receiver circuitry configured to receive, from an anchor cell, network energy saving (NES) cell information comprising an identity of a NES cell associated with the anchor cell, the NES cell being a cell that refrains from periodically transmitting broadcast signals for energy saving; and,
processor circuitry configured to perform, based on the NES cell information, an idle/inactive mode procedure.

2. The wireless terminal of claim 1, wherein the NES cell information further comprises information indicating whether or not the NES cell broadcasts a Synchronization Signal Block (SSB).

3. The wireless terminal of claim 1, wherein the NES cell information further comprises information indicating whether or not the NES cell broadcasts system information.

4. The wireless terminal of claim 2, wherein the idle/inactive procedure is to derive synchronization information of the NES cell.

5. The wireless terminal of claim 4, wherein the anchor cell's SSB is used to derive the synchronization information of the NES cell.

6. The wireless terminal of claim 5, wherein the NES cell information further comprises an indication indicating whether or not the anchor cell's SSB can be used to derive the synchronization information of the NES cell.

7. An access node of a cellular telecommunication system, the access node comprising:
processor circuitry configured to generate network energy saving (NES) cell information, the NES cell information being configured for use by a wireless terminal to perform an idle/inactive mode procedure and comprising an identity of a NES cell which refrains from periodically transmitting broadcast signals for energy saving; and,
transmitter circuitry configured to transmit the NES cell information via an anchor cell to the wireless terminal.

8. The access node of claim 7, wherein the NES cell information further comprises information indicating whether or not the NES cell broadcasts Synchronization Signal Block (SSB).

9. The access node of claim 7, wherein the NES cell information further comprises information indicating whether or not the NES cell broadcasts system information.

10. The access node of claim 8, wherein the idle/inactive procedure is to derive synchronization information of the NES cell.

11. The access node of claim 10, wherein the anchor cell's SSB is used to derive the synchronization information of the NES cell

12. The access node of claim 11, wherein the NES cell information further comprises an indication indicating whether or not the anchor cell's SSB can be used to derive the synchronization information of the NES cell.

13. A method for a wireless terminal of a cellular telecommunication system, the method comprising:
receiving, from an anchor cell, network energy saving (NES) cell information comprising an identity of a NES cell associated with the anchor cell, the NES cell being a cell that refrains from periodically transmitting broadcast signals for energy saving; and,
performing an idle/inactive mode procedure based on the NES cell information.
